(19) United States
(12) Patent Application Publication
(10) Pub. No.: US 2017/0339403 A1
(43) Pub. Date: Nov. 23, 2017

(54) METHOD AND DEVICE FOR ENCODING/DECODING VIDEO USING INTRA PREDICTION

(71) Applicant: SAMSUNG ELECTRONICS CO., LTD., Suwon-si (KR)

(72) Inventors: Jung-hye MIN, Yongin-si (KR); Elena ALSHINA, Suwon-si (KR); Yin-ji PIAO, Yongin-si (KR)

(73) Assignee: SAMSUNG ELECTRONICS CO., LTD., Suwon-si (KR)

(21) Appl. No.: 15/524,315

(22) PCT Filed: Sep. 16, 2015
(86) PCT No.: PCT/KR2015/009744

§ 371 Date: May 4, 2017

Related U.S. Application Data
(60) Provisional application No. 62/074,957, filed on Nov. 4, 2014.

(51) Int. Cl. H04N 19/105; H04N 19/593; H04N 19/176

(52) U.S. Cl. CPC H04N 19/105; H04N 19/593; H04N 19/176

(57) ABSTRACT

A video decoding method includes determining an intra prediction mode of a current lower block corresponding to one of a plurality of lower blocks generated by splitting an upper block, determining reference samples of the current lower block based on samples adjacent to the upper block, determining a predicted value of a current sample included in the current lower block, by using the reference samples based on the intra prediction mode, and reconstructing the current lower block based on the predicted value, wherein the current sample included in the current lower block is excluded from reference samples of another lower block included in the upper block.

### TECHNICAL FIELD

The present invention relates to a video encoding method and a video decoding method and, more particularly, to video encoding and decoding methods using an intra prediction method.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on coding units having a tree structure.

Image data of a spatial region is transformed into coefficients of a frequency region via frequency transformation According to a video codec, an image is split into blocks having a predetermined size, discrete cosine transformation (DCT) is performed on each block, and frequency coefficients are encoded in block units, for rapid calculation of frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. The amount of image data may be reduced by substituting data, which is continuously and repeatedly generated, with small-sized data.

### DETAILED DESCRIPTION OF THE INVENTION

### Technical Problem

To increase video encoding/decoding efficiency, an intra prediction method capable of changing the relationship between a prediction unit and a transformation unit is provided.

### Technical Solution

According to an aspect of an embodiment, a video decoding method includes determining an intra prediction mode of a current lower block corresponding to one of a plurality of lower blocks generated by splitting an upper block, determining reference samples of the current lower block based on samples adjacent to the upper block, determining a predicted value of a current sample included in the current lower block, by using the reference samples based on the intra prediction mode, and reconstructing the current lower block based on the predicted value, wherein the current sample included in the current lower block is excluded from reference samples of another lower block included in the upper block.

The upper block may be a coding unit, and the plurality of lower blocks may be prediction units included in the coding unit.

The determining of the reference samples may include determining all samples adjacent to the upper block, as the reference samples.

The determining of the reference samples may include determining samples located in a horizontal direction of the current lower block and samples located in a vertical direction of the current lower block among the samples adjacent to the upper block, as the reference samples.

The video decoding method may further include obtaining an upper block boundary intra prediction flag indicating whether the reference samples are determined based on the samples adjacent to the upper block.

The determining of the reference samples may include determining the samples adjacent to the upper block, as the reference samples of the current lower block if the upper block boundary intra prediction flag indicates that the reference samples are determined as the samples adjacent to the upper block.

The obtaining of the upper block boundary intra prediction flag may include obtaining the upper block boundary intra prediction flag with respect to the upper block or upper video data of the upper block.

The upper block may be predicted by performing the determining of the intra prediction mode, the determining of the reference samples, and the determining of the predicted value on all lower blocks included in the upper block.

The current lower block and other lower blocks included in the upper block may be predicted and reconstructed in parallel with each other.

The video decoding method may further include applying a smoothing filter to samples adjacent to boundaries between the predicted current lower block and other predicted lower blocks included in the upper block.

According to another aspect of an embodiment, a video decoding apparatus includes an intra prediction mode determiner configured to determine an intra prediction mode of a current lower block corresponding to one of a plurality of lower blocks generated by splitting an upper block, a reference sample determiner configured to determine reference samples of the current lower block based on samples adjacent to the upper block, a predictor configured to determine a predicted value of a current sample included in the current lower block, by using the reference samples based on the intra prediction mode, and a reconstructor configured to reconstruct the current lower block based on the predicted value, wherein the current sample included in the current lower block is excluded from reference samples of another lower block included in the upper block.

The upper block may be a coding unit, and the plurality of lower blocks may be prediction units included in the coding unit.

The reference sample determiner may determine all samples adjacent to the upper block, as the reference samples.

The reference sample determiner may determine samples located in a horizontal direction of the current lower block and samples located in a vertical direction of the current lower block among the samples adjacent to the upper block, as the reference samples.

The video decoding apparatus may further include an upper block boundary intra prediction flag obtainer for obtaining an upper block boundary intra prediction flag indicating whether the reference samples are determined based on the samples adjacent to the upper block.

The reference sample determiner may determine the samples adjacent to the upper block, as the reference samples of the current lower block if the upper block boundary intra prediction flag indicates that the reference samples are determined as the samples adjacent to the upper block.

The upper block boundary intra prediction flag obtainer may obtain the upper block boundary intra prediction flag with respect to the upper block or upper video data of the upper block.

The upper block may be predicted by performing functions of the intra prediction mode determiner, the reference sample determiner, and the predictor on all lower blocks included in the upper block.

The current lower block and other lower blocks included in the upper block may be predicted in parallel with each other.

The video decoding apparatus may further include a boundary filter for applying a smoothing filter to samples adjacent to boundaries between the predicted current lower block and other predicted lower blocks included in the upper block.

According to another aspect of an embodiment, a video encoding method includes determining reference samples of a current lower block included in an upper block, among samples adjacent to the upper block, determining an intra prediction mode of the current lower block, the intra prediction mode being optimized for the reference samples, determining a predicted value of a current sample included in the current lower block, by using the reference samples based on the intra prediction mode, and encoding the current lower block based on the predicted value, wherein the current sample included in the current lower block is excluded from reference samples of another lower block included in the upper block.

According to another aspect of an embodiment, a video encoding apparatus includes a reference sample determiner configured to determine reference samples of a current lower block included in an upper block, among samples adjacent to the upper block, an intra prediction mode determiner configured to determine an intra prediction mode of the current lower block, the intra prediction mode being optimized for the reference samples, a predictor configured to determine a predicted value of a current sample included in the current lower block, by using the reference samples based on the intra prediction mode, and an encoder for encoding the current lower block based on the predicted value, wherein the current sample included in the current lower block is excluded from reference samples of another lower block included in the upper block.

According to another aspect of an embodiment, a computer-readable recording medium has recorded thereon a computer program for executing the video decoding method and the video encoding method.

### Advantageous Effects of the Invention

Using samples adjacent to a coding unit, as reference samples, prediction units included in the coding unit may be predicted independently of and in parallel with each other. In addition, prediction of the prediction units may be performed independently of and in parallel with transformation of transformation units. Furthermore, the prediction units may have a variety of forms irrespective of the form of the transformation units.

Due to the above effects, video encoding/decoding efficiency is increased.

### DESCRIPTION OF THE DRAWINGS

FIG. 1A illustrates a block diagram of a video encoding apparatus based on coding units having a tree structure, according to an embodiment.

FIG. 1B illustrates a block diagram of a video decoding apparatus based on coding units having a tree structure, according to an embodiment.

FIG. 2 illustrates a concept of coding units, according to an embodiment.

FIG. 3A illustrates a block diagram of a video encoder based on coding units, according to an embodiment.

FIG. 3B illustrates a block diagram of a video decoder based on coding units, according to an embodiment.

FIG. 4 illustrates deeper coding units according to depths, and partitions, according to an embodiment.

FIG. 5 illustrates a relationship between a coding unit and transformation units, according to an embodiment.

FIG. 6 illustrates a plurality of pieces of encoding information according to depths, according to an embodiment.

FIG. 7 illustrates deeper coding units according to depths, according to an embodiment.

FIGS. 8, 9, and 10 illustrate a relationship between coding units, prediction units, and transformation units, according to an embodiment.

FIG. 11 illustrates a relationship between a coding unit, a prediction unit, and a transformation unit, according to encoding mode information of Table 1.

FIG. 12A is a block diagram of a video decoding apparatus according to an embodiment.

FIG. 12B is a flowchart of a video decoding method according to an embodiment.

FIG. 13A is a block diagram of a video encoding apparatus according to an embodiment.

FIG. 13B is a flowchart of a video encoding method according to an embodiment.

FIGS. 14A to 14D are diagrams for describing differences between an intra prediction method using samples adjacent to a prediction unit and an intra prediction method using samples adjacent to a coding unit.

FIG. 15 is a diagram for describing an intra prediction method using samples adjacent to a coding unit, according to an embodiment.

FIG. 16 is a diagram for describing a method of applying a smoothing filter between prediction units, according to an embodiment.

### BEST MODE

According to an aspect of an embodiment, a video decoding method includes determining an intra prediction mode of a current lower block corresponding to one of a plurality of lower blocks generated by splitting an upper block, determining reference samples of the current lower block based on samples adjacent to the upper block, determining a predicted value of a current sample included in the current lower block, by using the reference samples based on the intra prediction mode, and reconstructing the current lower block based on the predicted value, wherein the current sample included in the current lower block is excluded from reference samples of another lower block included in the upper block.

According to another aspect of an embodiment, a video decoding apparatus includes an intra prediction mode determiner configured to determine an intra prediction mode of a current lower block corresponding to one of a plurality of lower blocks generated by splitting an upper block, a reference sample determiner configured to determine reference samples of the current lower block based on samples adjacent to the upper block, a predictor configured to determine a predicted value of a current sample included in the current lower block, by using the reference samples based on the intra prediction mode, and a reconstructor configured to reconstruct the current lower block based on the predicted value, wherein the current sample included in the current lower block is excluded from reference samples of another lower block included in the upper block.

According to another aspect of an embodiment, a video encoding method includes determining reference samples of a current lower block included in an upper block, among samples adjacent to the upper block, determining an intra prediction mode of the current lower block, the intra prediction mode being optimized for the reference samples, determining a predicted value of a current sample included in the current lower block, by using the reference samples based on the intra prediction mode, and encoding the current lower block based on the predicted value, wherein the current sample included in the current lower block is excluded from reference samples of another lower block included in the upper block.

According to another aspect of an embodiment, a video encoding apparatus includes a reference sample determiner configured to determine reference samples of a current lower block included in an upper block, among samples adjacent to the upper block, an intra prediction mode determiner configured to determine an intra prediction mode of the current lower block, the intra prediction mode being optimized for the reference samples, a predictor configured to determine a predicted value of a current sample included in the current lower block, by using the reference samples based on the intra prediction mode, and an encoder for encoding the current lower block based on the predicted value, wherein the current sample included in the current lower block is excluded from reference samples of another lower block included in the upper block.

### MODE OF THE INVENTION

In the following description, an ‘image’ denotes a still image or a moving image such as a video. A ‘picture’ denotes a still image to be encoded or decoded.

A ‘sample’ denotes data that is assigned to a sampling location of an image and is to be processed. For example, pixels of an image in the spatial domain may be samples.

An intra prediction mode denotes a prediction mode for predicting samples of a picture by using continuity thereof.

A coordinate (x,y) is determined based on a sample located at a top left corner of a block. Specifically, the coordinate of the sample located at the top left corner of the block is determined to be (0,0). An x value of the coordinate is increased in a rightward direction, and a y value of the coordinate is increased in a downward direction.

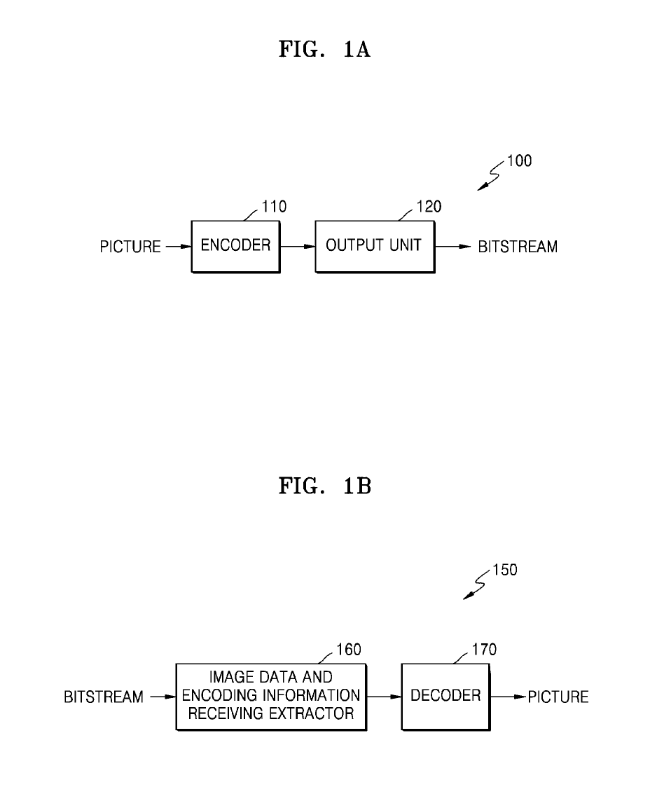

FIG. 1A is a block diagram of a video decoding apparatus 100 based on coding units having a tree structure, according to various embodiments.

The video encoding apparatus 100 for video prediction based on coding units having a tree structure includes an encoder 110 and an output unit 120. Hereinafter, for convenience of description, the video encoding apparatus involving video prediction based on coding units of the tree structure 100 according to the embodiment will be abbreviated to the ‘video encoding apparatus 100’.

The encoder 110 may split a current picture based on a largest coding unit that is a coding unit having a maximum size for a current picture of an image If the current picture is larger than the largest coding unit, image data of the current picture may be split into the at least one largest coding unit. The largest coding unit according to an embodiment may be a data unit having a size of 32×32, 64×64, 128×128, 256×256,etc., wherein a shape of the data unit is a square having a width and length in squares of 2.

A coding unit according to an embodiment may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit is an uppermost depth and a depth of the smallest coding unit is a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to an embodiment is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be predetermined.

The encoder 110 encodes at least one split region obtained by splitting a region of the largest coding unit according to depths, and determines a depth to output a finally encoded image data according to the at least one split region. In other words, the encoder 110 determines a coded depth by encoding the image data in the deeper coding units according to depths, according to the largest coding unit of the current picture, and selecting a depth having the minimum encoding error. The determined coded depth and image data according to largest coding units are output to the output unit 120.

The image data in the largest coding unit is encoded based on the deeper coding units corresponding to at least one depth equal to or below the maximum depth, and results of encoding the image data based on each of the deeper coding units are compared. A depth having the minimum encoding error may be selected after comparing encoding errors of the deeper coding units. At least one coded depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors according to depths may differ according to regions in the one largest coding unit, and thus the coded depths may differ according to regions in the image data. Thus, one or more coded depths may be determined in one largest coding unit, and the image data of the largest coding unit may be divided according to coding units of at least one coded depth.

Accordingly, the encoder 110 according to an embodiment may determine coding units having a tree structure and included in the current largest coding unit. The ‘coding units having a tree structure’ according to an embodiment include coding units corresponding to a depth determined to be the coded depth, from among all deeper coding units included in the current largest coding unit. A coding unit of a coded depth may be hierarchically determined according to depths in the same region of the largest coding unit, and may be independently determined in different regions. Equally, a coded depth in a current region may be independently determined from a coded depth in another region.

A maximum depth according to an embodiment is an index related to the number of splitting times from a largest coding unit to a smallest coding unit. A maximum depth according to an embodiment may denote the total number of splitting times from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. In this case, if a coding unit obtained by splitting the largest coding unit four times corresponds to the smallest coding unit, since depth levels of 0, 1, 2, 3, and 4 are present, the maximum depth may be set to 4.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. Hereinafter, for convenience of description, the prediction encoding and the transformation will be described based on a coding unit of a current depth in at least one largest coding unit.

The video encoding apparatus 100 according to the embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but may also select a data unit different from the coding unit so as to perform the prediction encoding on the image data in the coding unit.

In order to perform prediction encoding in the largest coding unit, the prediction encoding may be performed based on a coding unit corresponding to a coded depth according to an embodiment, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type may include symmetrical partitions obtained by symmetrically splitting a height or width of the prediction unit, and may selectively include partitions obtained by asymmetrically splitting the height or width of the prediction unit, such as 1:n or n:1, partitions obtained by geometrically splitting the prediction unit, partitions having arbitrary shapes, or the like.

A prediction mode of the prediction unit may be at least one of an intra mode, an inter mode, and a skip mode. For example, the intra mode and the inter mode may be performed on the partition of 2N×2N, 2N×N, N×2N, or N×N. Also, the skip mode may be performed only on the partition of 2N×2N. The encoding may be independently performed on one prediction unit in a coding unit, so that a prediction mode having a minimum encoding error may be selected.

The video encoding apparatus 100 according to the embodiment may also perform the transformation on the image data in a coding unit based on not only the coding unit for encoding the image data, but also based on a data unit that is different from the coding unit. In order to perform the transformation in the coding unit, the transformation may be performed based on a transformation unit having a size smaller than or equal to the coding unit. For example, the transformation unit may include a data unit for an intra mode and a transformation unit for an inter mode.

The transformation unit in the coding unit may be recursively split into smaller sized regions in a manner similar to that in which the coding unit is split according to the tree structure, according to an embodiment. Thus, residual data in the coding unit may be split according to the transformation unit having a tree structure according to transformation depths.

A transformation depth indicating the number of splitting times to reach the transformation unit by splitting the height and width of the coding unit may also be set in the transformation unit according to an embodiment. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. That is, with respect to the transformation unit, the transformation unit having the tree structure may be set according to the transformation depths.

Encoding information according to coded depths requires not only the coded depth but also information about prediction and information about transformation. Accordingly, the encoder 110 not only determines a depth having a minimum encoding error but also determines a partition mode in which a prediction unit is split to partitions, a prediction mode according to prediction units, and a size of a transformation unit for transformation.

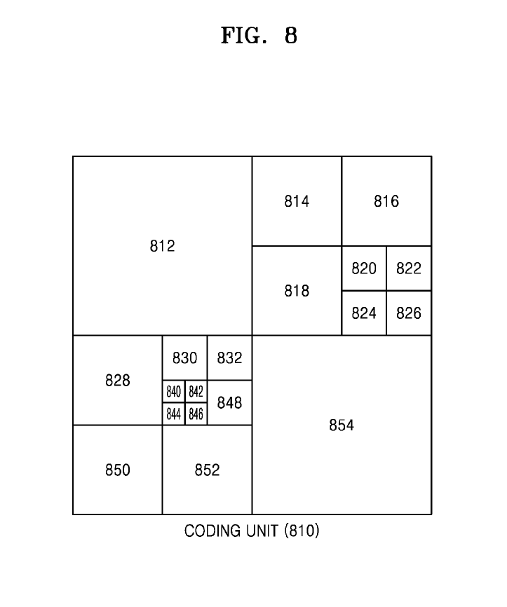

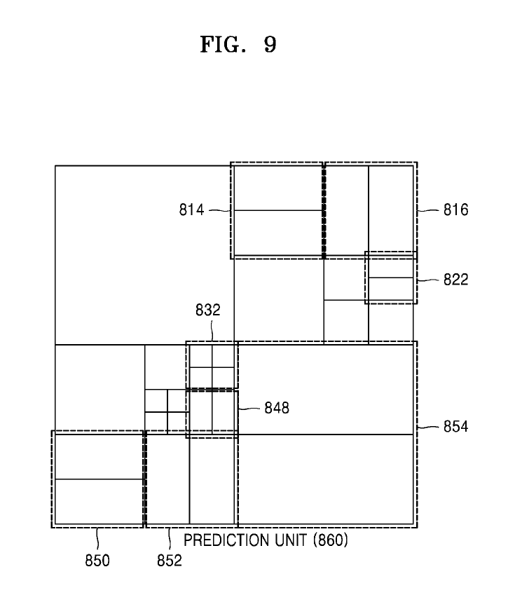

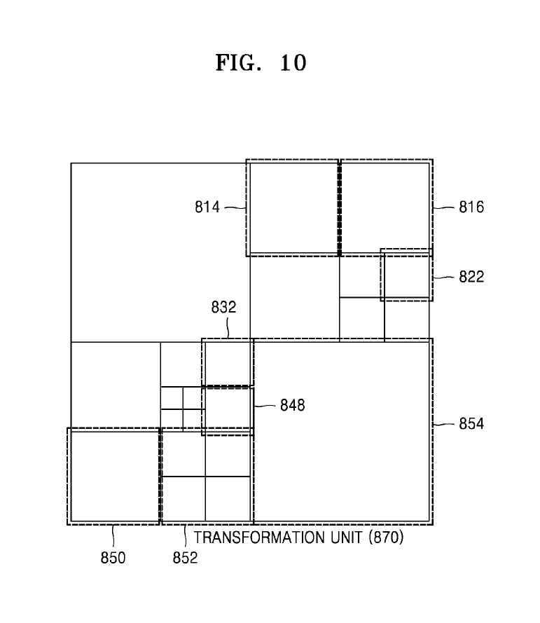

Coding units having a tree structure in a largest coding unit and methods of determining a prediction unit/partition, and a transformation unit, according to embodiments, will be described in detail later with reference to FIGS. 8 through 24.

The encoder 110 may measure an encoding error of deeper coding units according to depths by using Rate-Distortion Optimization based on Lagrangian multipliers.

The output unit 120 outputs, in bitstreams, the image data of the largest coding unit, which is encoded based on the at least one coded depth determined by the encoder 120, and encoding mode information according to depths.

The encoded image data may be obtained by encoding residual data of an image.

The encoding mode information according to depths may include coded depth information, partition type information of a prediction unit, prediction mode information, and transformation unit size information.

Coded depth information may be defined by using split information according to depths, which specifies whether encoding is performed on coding units of a lower depth instead of a current depth. If the current depth of the current coding unit is a coded depth, the current coding unit is encoded, and thus the split information may be defined not to split the current coding unit to a lower depth. On the contrary, if the current depth of the current coding unit is not the coded depth, the encoding has to be performed on the coding unit of the lower depth, and thus the split information of the current depth may be defined to split the current coding unit to the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since coding units having a tree structure are determined within one largest coding unit and information about at least one encoding mode should be determined for coding units of each coded depth, information about at least one encoding mode may be determined with respect to one largest coding unit. Also, a coded depth of the image data of the largest coding unit may be different according to locations since the image data is hierarchically split according to depths, and thus information about the coded depth and the encoding mode may be set for the image data.

Accordingly, the output unit 120 according to the embodiment may assign encoding information about a corresponding coded depth and an encoding mode to at least one of the coding unit, the prediction unit, and a smallest unit included in the largest coding unit.

The smallest unit according to an embodiment is a square data unit obtained by splitting the smallest coding unit constituting the lowermost coded depth by 4. Alternatively, the smallest unit according to an embodiment may be a maximum square data unit that may be included in all of the coding units, prediction units, partition units, and transformation units included in the largest coding unit.

For example, the encoding information output by the output unit 120 may be classified into encoding information according to deeper coding units, and encoding information according to prediction units. The encoding information according to the deeper coding units may include the prediction mode information and the partition size information. The encoding information according to the prediction units may include information about an estimated direction during an inter mode, about a reference image index of the inter mode, about a motion vector, about a chroma component of an intra mode, and about an interpolation method during the intra mode.

Information about a maximum size of the coding unit defined according to pictures, slice segments, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The output unit 120 may encode and output reference information, prediction information, and slice segment type information, which are related to prediction.

According to the simplest embodiment of the video encoding apparatus 100, the deeper coding unit may be a coding unit obtained by dividing a height and width of a coding unit of an upper depth, which is one layer above, by two. That is, when the size of the coding unit of the current depth is 2N×2N, the size of the coding unit of the lower depth is N×N. Also, a current coding unit having a size of 2N×2N may maximally include four lower-depth coding units having a size of N×N.

Accordingly, the video encoding apparatus 100 may form the coding units having a tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimum encoding mode may be determined by taking into account characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus according to the embodiment, image compression efficiency may be increased since a coding unit is adjusted while considering characteristics of an image while increasing a maximum size of a coding unit while considering a size of the image.

FIG. 1B is a block diagram of a video decoding apparatus 150 based on coding units having a tree structure, according to various embodiments.

According to an embodiment, the video decoding apparatus 150 for video prediction based on coding units having a tree structure includes an image data and encoding information receiver and extractor 160 and a decoder 170. Hereinafter, for convenience of description, the video decoding apparatus 150 for video prediction based on coding units having a tree structure according to the embodiment will be abbreviated to the ‘video decoding apparatus 150’.

Definitions of various terms such as coding unit, depth, prediction unit, transformation unit, and information about various encoding modes for a decoding operation of the video decoding apparatus 150 according to an embodiment are as described above in relation to FIG. 8 and the video encoding apparatus 100.

The receiver and extractor 160 receives and parses a bitstream of an encoded video. The image data and encoding information receiver and extractor 160 extracts encoded image data of each of coding units having a tree structure according to each largest coding unit, from the parsed bitstream, and outputs the extracted data to the decoder 170. The image data and encoding information receiver and extractor 160 may extract information about a maximum size of a coding unit of a current picture, from a header about the current picture, a sequence parameter set, or a picture parameter set.

Also, the image data and encoding information receiver and extractor 160 extracts coded depth and encoding mode information for the coding units having a tree structure according to each largest coding unit, from the parsed bitstream. The extracted coded depth and encoding mode information is output to the decoder 170. That is, the image data of the bitstream may be split into largest coding units in such a manner that the decoder 170 decodes the image data of each largest coding unit.

The coded depth and encoding mode information according to each largest coding unit may be set with respect to one or more pieces of coded depth information, and the encoding mode information according to coded depths may include, for example, partition type information, prediction mode information, and transformation unit size information of a corresponding coding unit. Also, split information according to depths may be extracted as the information about a coded depth.

As in the video encoding apparatus 100 according to an embodiment, the coded depth and encoding mode information according to each largest coding unit, which is extracted by the image data and encoding information receiver and extractor 160, is coded depth and encoding mode information which is determined to generate a minimum encoding error by repeatedly encoding coding units according to largest coding units and depths by an encoder. Accordingly, the video decoding apparatus 150 may reconstruct an image by decoding data according to an encoding method that generates the minimum encoding error.

Since the coded depth and encoding mode information according to an embodiment may be assigned to a predetermined data unit among a corresponding coding unit, a prediction unit, and a smallest unit, the image data and encoding information receiver and extractor 160 may extract the coded depth and encoding mode information according to each predetermined data unit. When coded depth and encoding mode information of a corresponding largest coding unit is assigned to each of predetermined data units, the predetermined data units to which the same coded depth and encoding mode information is assigned may be inferred to be the data units included in the same largest coding unit.

The decoder 170 reconstructs a current picture by decoding the image data of each largest coding unit based on the coded depth and encoding mode information according to each largest coding unit. That is, the decoder 170 may decode the encoded image data, based on a read partition mode, a prediction type, and a transformation unit for each coding unit from among the coding units having a tree structure and included in each largest coding unit. A decoding process may include a prediction process including intra prediction and motion compensation, and an inverse transformation process.

The decoder 170 may perform intra prediction or motion compensation according to a partition and a prediction mode of each coding unit, based on the partition mode information and the prediction type information about the prediction unit of the coding unit according to coded depths.

In addition, the decoder 170 may read information about transformation units having a tree structure for each coding unit so as to perform inverse transformation based on transformation units for each coding unit, for inverse transformation for each largest coding unit. Via the inverse transformation, a pixel value of a spatial region of the coding unit may be reconstructed.

The decoder 170 may determine a coded depth of a current largest coding unit by using split information according to depths. If the split information indicates that image data is no longer split in the current depth, the current depth is a coded depth. Accordingly, the decoder 170 may decode the image data of the current largest coding unit by using the information about the partition mode of the prediction unit, the prediction type, and the size of the transformation unit for each coding unit corresponding to the current depth.

That is, data units containing the encoding information including the same split information may be gathered by observing the encoding information set assigned for the predetermined data unit from among the coding unit, the prediction unit, and the smallest unit, and the gathered data units may be considered to be one data unit to be decoded by the decoder 170 in the same encoding mode. As such, the current coding unit may be decoded by obtaining the information about the encoding mode for each coding unit.

The receiver and extractor 160 may obtain a sample adaptive offset (SAO) type and an offset from the received current layer bitstream, may determine an SAO category based on distribution of sample values for each sample of a current layer predicted image, and thus may obtain an offset according to each SAO category by using the SAO type and the offset. Therefore, although a prediction error of each sample is not received, the decoder 170 may compensate the offset according to each category for each sample of the current layer predicted image, and may determine a current layer reconstructed image with reference to the compensated current layer predicted image.

Consequently, the video decoding apparatus 150 may obtain information about a coding unit which generates a minimum encoding error, by recursively encoding each largest coding unit in an encoding process, and may use the obtained information to decode the current picture. That is, the coding units having a tree structure determined to be the optimum coding units in each largest coding unit may be decoded.

Accordingly, even if an image has high resolution or has an excessively large data amount, the image may be efficiently decoded and reconstructed by using a size of a coding unit and an encoding mode, which are adaptively determined according to characteristics of the image, by using optimum encoding mode information received from an encoder.

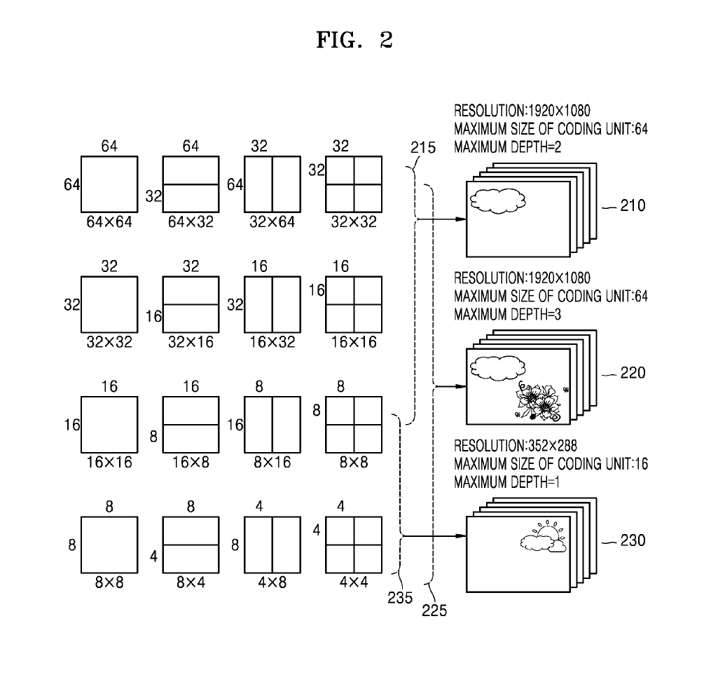

FIG. 2 illustrates a concept of coding units, according to various embodiments.

A size of a coding unit may be expressed by width x height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 210, a resolution is 1920×1080, a maximum size of a coding unit is 64, and a maximum depth is 2. In video data 220, a resolution is 1920×1080, a maximum size of a coding unit is 64, and a maximum depth is 3. In video data 230, a resolution is 352×288, a maximum size of a coding unit is 16, and a maximum depth is 1. The maximum depth shown in FIG. 8 denotes a total number of splits from a largest coding unit to a smallest coding unit.

If a resolution is high or a data amount is large, a maximum size of a coding unit may be large so as to not only increase encoding efficiency but also to accurately reflect characteristics of an image. Accordingly, the maximum size of the coding unit of the video data 210 and 220 having a higher resolution than the video data 230 may be selected to 64.

Since the maximum depth of the video data 210 is 2, coding units 315 of the video data 210 may include a largest coding unit having a long axis size of 64, and coding units having long axis sizes of 32 and 16 since depths are deepened to two layers by splitting the largest coding unit twice. Since the maximum depth of the video data 230 is 1, coding units 235 of the video data 230 may include a largest coding unit having a long axis size of 16, and coding units having a long axis size of 8 since depths are deepened to one layer by splitting the largest coding unit once.

Since the maximum depth of the video data 220 is 3, coding units 225 of the video data 220 may include a largest coding unit having a long axis size of 64, and coding units having long axis sizes of 32, 16, and 8 since the depths are deepened to 3 layers by splitting the largest coding unit three times. As a depth deepens, an expression capability with respect to detailed information may be improved.

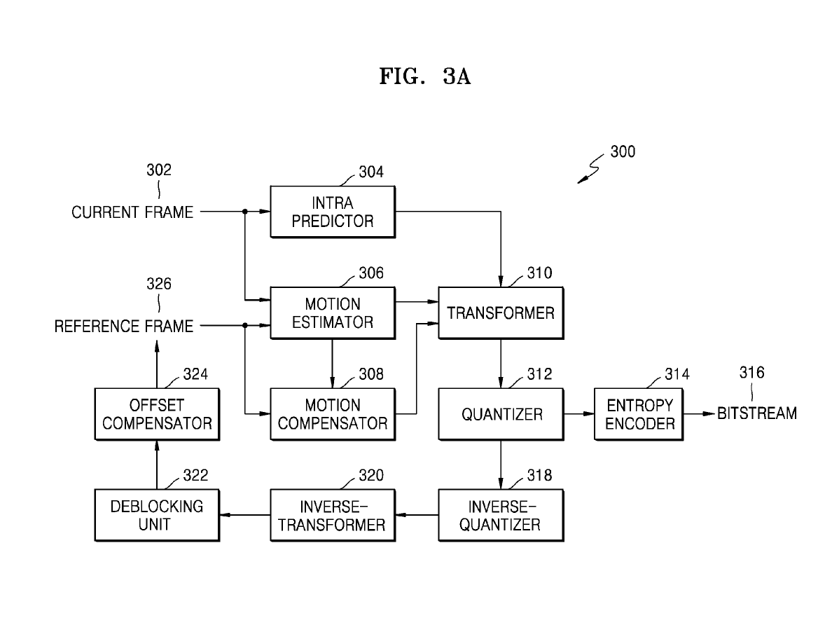

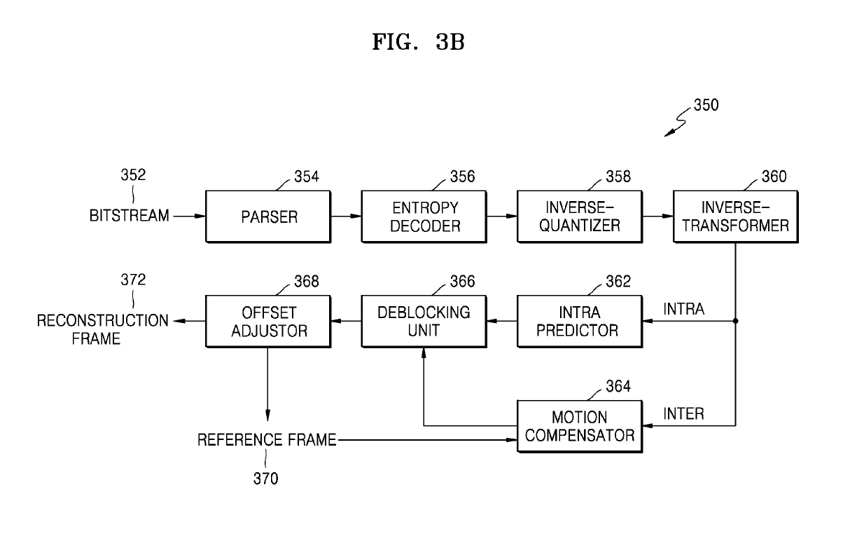

FIG. 3A is a block diagram of a video encoder 300 based on coding units, according to various embodiments.

The video encoder 300 according to an embodiment includes operations of the encoder 210 of the video encoding apparatus 100 so as to encode image data. That is, an intra predictor 304 performs intra prediction on coding units in an intra mode, with respect to a current frame 302, and a motion estimator 306 and a motion compensator 308 respectively perform inter estimation and motion compensation on coding units in an inter mode by using the current frame 302 and a reference frame 326.

The data output from the intra predictor 304, the motion estimator 306, and the motion compensator 308 is output as a quantized transformation coefficient through a transformer 310 and a quantizer 312. The quantized transformation coefficient is reconstructed into data of the spatial domain through an inverse quantizer 318 and an inverse transformer 320, and the reconstructed data of the spatial domain is post-processed through a deblocking unit 322 and an offset compensator 324 and is output as a reference frame 326. The quantized transformation coefficient may be output as a bitstream 316 through an entropy encoder 314.

In order for the video encoder 300 to be applied in the video encoding apparatus 100, all elements of the video encoder 300, i.e., the intra predictor 304, the motion estimator 306, the motion compensator 308, the transformer 310, the quantizer 312, the entropy encoder 314, the inverse quantizer 318, the inverse transformer 320, the deblocking unit 322, and the offset compensator 324, have to perform operations based on each coding unit from among coding units having a tree structure while considering the maximum depth of each largest coding unit.

Specifically, the intra predictor 304, the motion estimator 306, and the motion compensator 308 determine partitions and a prediction mode of each coding unit from among the coding units having a tree structure while considering the maximum size and the maximum depth of a current largest coding unit, and the transformer 310 determines the size of the transformation unit in each coding unit from among the coding units having a tree structure.

FIG. 3B is a block diagram of a video decoder 350 based on coding units according to various embodiments.

A bitstream 352 is passed through a parser 354 and thus encoded image data to be decoded, and encoding information necessary for decoding are parsed. The encoded image data is output as inversely quantized data through an entropy decoder 356 and an inverse quantizer 358, and is reconstructed into image data of the spatial domain through an inverse transformer 360.

With respect to the image data of the spatial domain, an intra predictor 362 performs intra prediction on a coding unit of an intra mode, and a motion compensator 364 performs motion compensation on a coding unit of an inter mode by using a reference frame 370.

The data of the spatial domain passed through the intra predictor 362 and the motion compensator 364 is post-processed through a deblocking unit 366 and an offset compensator 368, and may be output as a reconstructed frame 372. In addition, the data post-processed through the deblocking unit 366 and the offset compensator 368 may be output as the reference frame 370.

To decode image data by the decoder 170 of the video decoding apparatus 150, sequential operations after the parser 354 of the video decoder 350 according to an embodiment may be performed.

In order for the video decoder 350 to be applied in the video decoding apparatus 200, all elements of the video decoder 350, i.e., the parser 354, the entropy decoder 356, the inverse quantizer 358, the inverse transformer 360, the intra predictor 362, the motion compensator 364, the deblocking unit 366, and the offset compensator 368, perform operations based on coding units having a tree structure for each largest coding unit.

Specifically, the intra predictor 362 and the motion compensator 364 determine a partition and a prediction mode for each coding unit having a tree structure, and the inverse transformer 360 has to determine a size of a transformation unit for each coding unit.

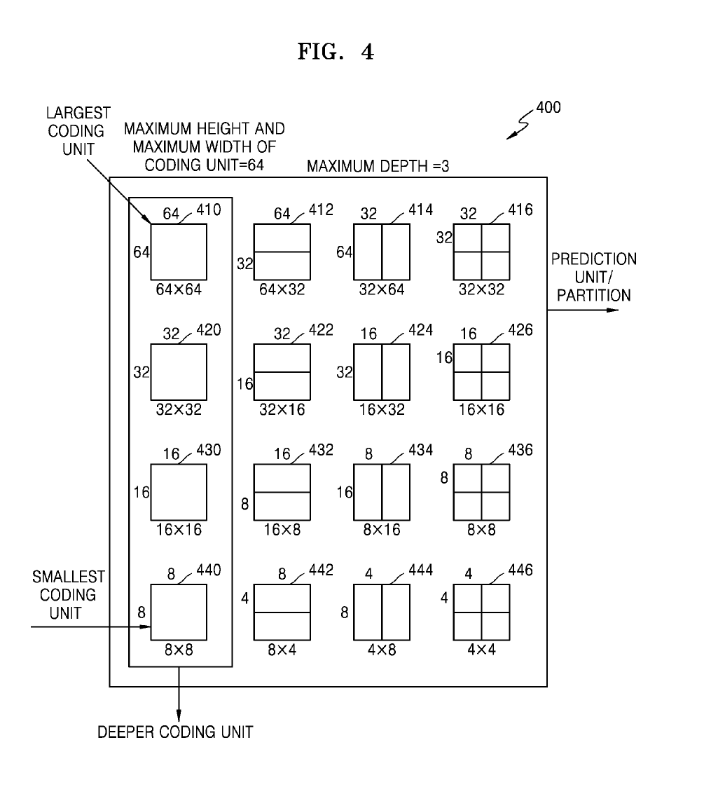

FIG. 4 illustrates deeper coding units according to depths, and partitions, according to various embodiments.

The video encoding apparatus 100 according to an embodiment and the video decoding apparatus 150 according to an embodiment use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure of coding units 400 according to an embodiment, the maximum height and the maximum width of the coding units are each 64, and the maximum depth is 3. In this case, the maximum depth refers to a total number of times the coding unit is split from the largest coding unit to the smallest coding unit. Since a depth deepens along a vertical axis of the hierarchical structure of coding units 400, a height and a width of the deeper coding unit are each split. Also, a prediction unit and partitions, which are bases for prediction encoding of each deeper coding unit, are shown along a horizontal axis of the hierarchical structure of coding units 400.

That is, a coding unit 410 is a largest coding unit in the hierarchical structure of coding units 400, wherein a depth is 0 and a size, i.e., a height by width, is 64×64. The depth deepens along the vertical axis, and a coding unit 420 having a size of 32×32 and a depth of 1, a coding unit 430 having a size of 16×16 and a depth of 2, and a coding unit 440 having a size of 8×8 and a depth of 3 are present. The coding unit 440 having a size of 8×8 and a depth of 3 is a smallest coding unit.

The prediction unit and the partitions of a coding unit are arranged along the horizontal axis according to each depth. In other words, if the coding unit 410 having a size of 64×64 and a depth of 0 is a prediction unit, the prediction unit may be split into partitions included in the coding unit 410 having a size of 64×64, i.e. a partition 410 having a size of 64×64, partitions 412 having the size of 64×32, partitions 414 having the size of 32×64, or partitions 416 having the size of 32×32.

Equally, a prediction unit of the coding unit 420 having the size of 32×32and the depth of 1 may be split into partitions included in the coding unit 420 having a size of 32×32, i.e. a partition 420 having a size of 32×32, partitions 422 having a size of 32×16, partitions 424 having a size of 16×32, and partitions 426 having a size of 16×16.

Equally, a prediction unit of the coding unit 430 having the size of 16×16and the depth of 2 may be split into partitions included in the coding unit 430 having a size of 16×16, i.e. a partition having a size of 16×16 included in the coding unit 430, partitions 432 having a size of 16×8, partitions 434 having a size of 8×16, and partitions 436 having a size of 8×8.

Equally, a prediction unit of the coding unit 440 having the size of 8×8and the depth of 3 may be split into partitions included in the coding unit 440 having a size of 8×8, i.e. a partition 440 having a size of 8×8 included in the coding unit 440, partitions 442 having a size of 8×4, partitions 444 having a size of 4×8, and partitions 446 having a size of 4×4.

In order to determine a coded depth of the largest coding unit 410, the encoder 110 of the video encoding apparatus 100 has to perform encoding on coding units respectively corresponding to depths included in the largest coding unit 410.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare results of encoding the same data according to depths, the data has to be encoded by using each of the coding unit corresponding to the depth of 1 and four coding units corresponding to the depth of 2.

In order to perform encoding according to each of the depths, a minimum encoding error that is a representative encoding error of a corresponding depth may be selected by performing encoding on each of prediction units of the coding units according to depths, along the horizontal axis of the hierarchical structure of coding units 400. Alternatively, the minimum encoding error may be searched for by comparing the minimum encoding errors according to depths, by performing encoding for each depth as the depth deepens along the vertical axis of the hierarchical structure of coding units 400. A depth and a partition generating the minimum encoding error in the largest coding unit 1310 may be selected as a coded depth and a partition type of the largest coding unit 1310.

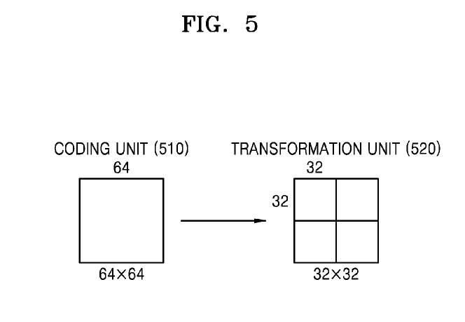

FIG. 5 illustrates a relationship between a coding unit and transformation units, according to various embodiments.

The video encoding apparatus 100 according to an embodiment or the video decoding apparatus 150 according to an embodiment encodes or decodes an image according to coding units having sizes smaller than or equal to a largest coding unit for each largest coding unit. Sizes of transformation units for transformation during encoding may be selected based on data units that are not larger than a corresponding coding unit.

For example, in the video encoding apparatus 100 according to an embodiment or the video decoding apparatus 150 according to an embodiment, if a size of a coding unit 510 is 64×64, transformation may be performed by using a transformation units 520 having a size of 32×32.

Also, data of the coding unit 510 having the size of 64×64 may be encoded by performing the transformation on each of the transformation units having the size of 32×32, 16×16, 8×8, and 4×4, which are smaller than 64×64, and then a transformation unit having the minimum coding error with respect to an original image may be selected.

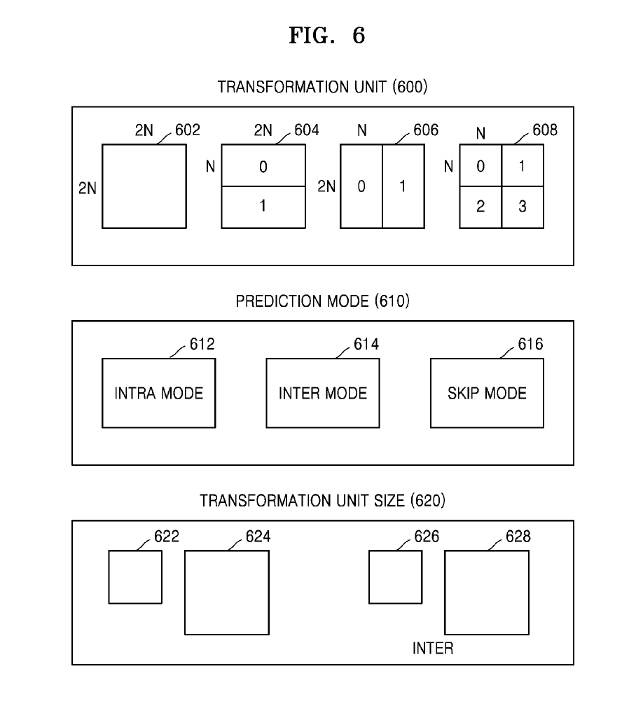

FIG. 6 illustrates a plurality of pieces of encoding information, according to various embodiments.

An output unit 120 of the video encoding apparatus 100 may encode and transmit partition mode information 600, prediction mode information 610, and transformation unit size information 620 for each coding unit corresponding to a coded depth, as the encoding mode information.

The partition type information 600 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 604 having a size of 2N×N, a partition 606 having a size of N×2N, and a partition 608 having a size of N×N. In this case, the partition type information 600 about a current coding unit is set to indicate one of the partition 602 having a size of 2N×2N, the partition 604 having a size of 2N×N, the partition 606 having a size of N×2N, and the partition 608 having a size of N×N.

The prediction mode information 610 indicates a prediction mode of each partition. For example, the prediction type information 610 may indicate a mode of prediction encoding performed on a partition indicated by the partition mode information 600, i.e., an intra mode 812, an inter mode 614, or a skip mode 616.

The transformation unit size information 620 represents a transformation unit to be based on when transformation is performed on a current coding unit. For example, the transformation unit may be a first intra transformation unit 622, a second intra transformation unit 624, a first inter transformation unit 626, or a second inter transformation unit 628.

The receiver and extractor 160 of the video decoding apparatus 150 according to an embodiment may extract the partition type information 600, the prediction mode information 610, and the transformation unit size information 620 for coding units of each depth, and may use the same for decoding.

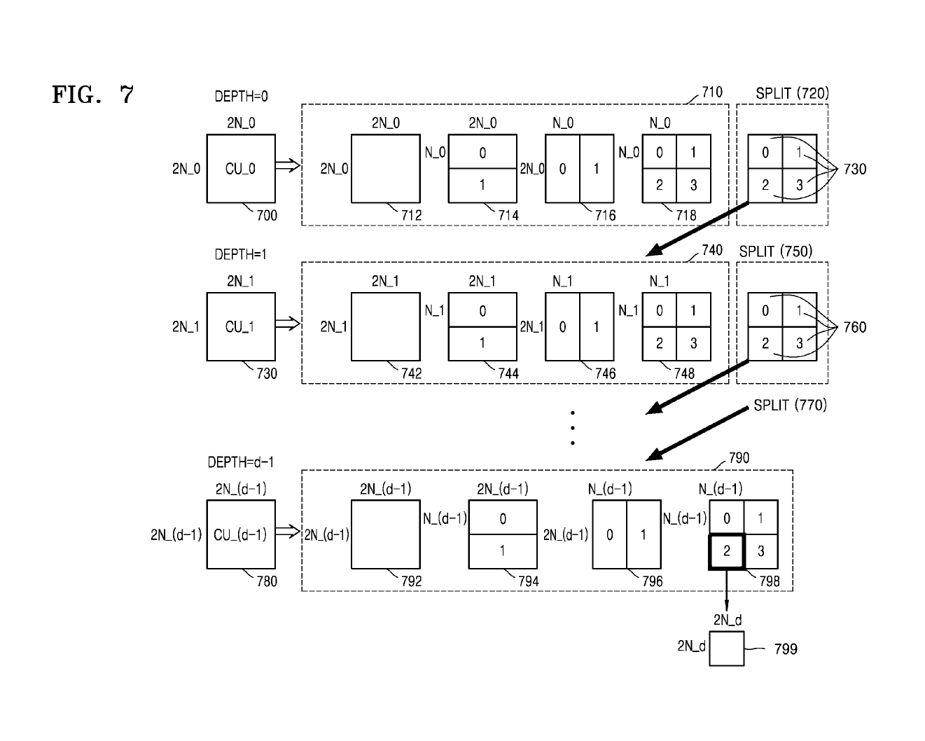

FIG. 7 illustrates deeper coding units according to depths, according to various embodiments.

Split information may be used to indicate a change in a depth. The spilt information indicates whether a coding unit of a current depth is split into coding units of a lower depth.

A prediction unit 710 for prediction encoding a coding unit 700 having a depth of 0 and a size of 2N_0×2N_0 may include partitions of a partition type 712 having a size of 2N_0×2N_0, a partition type 714 having a size of 2N_0×N_0, a partition type 716 having a size of N_0×2N_0, and a partition type 718 having a size of N_0×N_0. Although all of the illustrated partitions 712, 714, 716, and 718 are symmetrically split, as described above, the partition type is not limited thereto and may include asymmetric partitions, arbitrary partitions, geometric partitions, etc.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition type. The prediction encoding in an intra mode and an inter mode may be performed on the partitions having the sizes of 2N_0×2N_0, N_0×2N_0, 2N_0×N_0, and N_0×N_0. The prediction encoding in a skip mode may be performed only on the partition having the size of 2N_0×2N_0.

If an encoding error is smallest in one of the partition types 712, 714, and 716 having the sizes of 2N_0×2N_0, 2N_0×N_0 and N_0×2N_0, the prediction unit 910 may not be split into a lower depth.

If the encoding error is the smallest in the partition type 718 having the size of N_0×N_0, a depth is changed from 0 to 1 and split is performed (operation 720), and encoding may be repeatedly performed on coding units 730 of a partition type having a depth of 2 and a size of N_0×N_0 so as to search for a minimum encoding error.

A prediction unit 740 for prediction encoding the coding unit 730 having a depth of 1 and a size of 2N_1×2N_1 (=N_0×N_0) may include a partition type 742 having a size of 2N_1×2N_1, a partition type 744 having a size of 2N_1×N_1, a partition type 746 having a size of N_1×2N_1, and a partition type 748 having a size of N_1×N_1.

If an encoding error is the smallest in the partition type 748 having the size of N_1×N_1, a depth is changed from 1 to 2 and split is performed (in operation 750), and encoding is repeatedly performed on coding units 760 having a depth of 2 and a size of N_2×N_2 so as to search for a minimum encoding error.

When a maximum depth is d, deeper coding units according to depths may be set until when a depth corresponds to d-1, and split information may be set until when a depth corresponds to d-2. That is, when encoding is performed up to when the depth is d-1 after a coding unit corresponding to a depth of d-2 is split (in operation 770), a prediction unit 790 for prediction encoding a coding unit 780 having a depth of d-1 and a size of 2N_(d-1)×2N_(d-1) may include partitions of a partition type 792 having a size of 2N_(d-1)×2N_(d-1), a partition type 794 having a size of 2N_(d-1)×N_(d-1), a partition type 796 having a size of N_(d-1)×2N_(d-1), and a partition type 798 having a size of N_(d-1)×N_(d-1).

Prediction encoding may be repeatedly performed on one partition having a size of 2N_(d-1)×2N_(d-1), two partitions having a size of 2N_(d-1)×N_(d-1), two partitions having a size of N_(d-1)×2N_(d-1), four partitions having a size of N_(d-1)×N_(d-1) from among the partition types so as to search for a partition type generating a minimum encoding error.

Even when the partition type 798 having the size of N_(d-1)×N_(d-1) has the minimum encoding error, since a maximum depth is d, a coding unit CU_(d-1) having a depth of d-1 is no longer split into a lower depth, and a coded depth for the coding units constituting a current largest coding unit 700 is determined to be d-1 and a partition type of the current largest coding unit 700 may be determined to be N_(d-1)×N_(d-1). Also, since the maximum depth is d, split information for a coding unit 752 having a depth of d-1 is not set.

A data unit 799 may be a ‘smallest unit’ for the current largest coding unit. A smallest unit according to the embodiment may be a square data unit obtained by splitting a smallest coding unit having a lowermost coded depth by 4. By performing the encoding repeatedly, the video encoding apparatus 100 according to the embodiment may select a coded depth having the minimum encoding error by comparing encoding errors according to depths of the coding unit 700 to determine a depth, and set a corresponding partition type and a prediction mode as an encoding mode of the coded depth.

As such, the minimum encoding errors according to depths are compared in all of the depths of 0, 1, . . . , d-1, d, and a depth having a minimum encoding error may be determined as a coded depth. The coded depth, and the partition type and the prediction mode of the prediction unit may be encoded and transmitted as encoding mode information. In addition, since a coding unit should be split from depth 0 to the coded depth, only split information of the coded depth should be set to ‘0’ and split information according to depths other than the coded depth should be set to ‘1’.

The image data and encoding information receiver and extractor 160 of the video decoding apparatus 150 according to the embodiment may extract and use a coded depth and prediction unit information about the coding unit 700 so as to decode the coding unit 712. The video decoding apparatus 150 according to the embodiment may determine a depth, in which split information is ‘0’, as a coded depth by using split information according to depths, and may use, for decoding, encoding mode information about the corresponding depth.

FIGS. 8, 9, and 10 illustrate a relationship between coding units, prediction units, and transformation units, according to various embodiments.

Coding units 810 are deeper coding units according to coded depths determined by the video encoding apparatus 100, in a largest coding unit. Prediction units 860 are partitions of prediction units of each of the coding units 810 according to coded depths, and transformation units 870 are transformation units of each of the coding units according to coded depths.

When the depth of a largest coding unit among the coding units 810 according to depths is 0, coding units 812 have a depth of 1, coding units 814, 816, 818, 828, 850, and 852 have a depth of 2, coding units 820, 822, 824, 826, 830, 832, and 848 have a depth of 3, and coding units 840, 842, 844, and 846 have a depth of 4.

Coding units are split in some partitions 814, 816, 822, 832, 848, 850, 852, and 854 of the prediction units 860. That is, the partitions 814, 822, 850, and 854 have a partition type of 2N×N, the partitions 816, 848, and 852 have a partition type of N×2N, and the partition 832 has a partition type of N×N. Prediction units and partitions of the coding units 810 are smaller than or equal to each coding unit.

Transformation or inverse transformation is performed on image data of the coding unit 852 in the transformation units 870 in a data unit that is smaller than the coding unit 852. In addition, transformation units 814, 816, 822, 832, 848, 850, 852, and 854 are data units having sizes or shapes different from those of corresponding prediction units and partitions of the prediction units 860. That is, the video encoding apparatus 100 and the video decoding apparatus 150 according to the embodiments may perform intra prediction/motion estimation/motion compensation/and transformation/inverse transformation on an individual data unit in the same coding unit.

Accordingly, encoding is recursively performed on each of coding units having a hierarchical structure in each region of a largest coding unit so as to determine an optimum coding unit, and thus coding units having a recursive tree structure may be obtained. Encoding information may include split information about a coding unit, partition type information, prediction mode information, and transformation unit size information.

The output unit 120 of the video encoding apparatus 100 according to the embodiment may output the encoding information about the coding units having a tree structure, and the image data and encoding information receiver and extractor 160 of the video decoding apparatus 150 according to the embodiment may extract the encoding information about the coding units having a tree structure from a received bitstream.

Split information specifies whether a current coding unit is split into coding units of a lower depth. If split information of a current depth d is 0, a depth, in which a current coding unit is no longer split into a lower depth, is a coded depth, and thus partition type information, prediction mode information, and transformation unit size information may be defined for the coded depth. If the current coding unit is further split according to the split information, encoding has to be independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The partition type information may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1.

The size of the transformation unit may be set to be two types in the intra mode and two types in the inter mode. That is, if split information of the transformation unit is 0, the size of the transformation unit may be 2N×2N, which is the size of the current coding unit. If split information of the transformation unit is 1,the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure according to the embodiment may be assigned to at least one of a coding unit corresponding to a coded depth, a prediction unit, and a smallest unit. The coding unit corresponding to the coded depth may include at least one of a prediction unit and a smallest unit containing the same encoding information.

Accordingly, it is determined whether adjacent data units are included in the coding unit corresponding to the same coded depth by comparing a plurality of pieces of encoding information of the adjacent data units. Also, a corresponding coding unit corresponding to a coded depth is determined by using encoding information of a data unit, and thus a distribution of coded depths in a largest coding unit may be inferred.

Accordingly, if a current coding unit is predicted by referring to adjacent data units, encoding information of data units in deeper coding units adjacent to the current coding unit may be directly referred to and used.

In another embodiment, if a current coding unit is prediction-encoded based on adjacent data units, the adjacent data units may be referred to in a manner that data adjacent to the current coding unit is searched for in deeper coding units by using encoding information of the deeper coding units adjacent to the current coding unit.

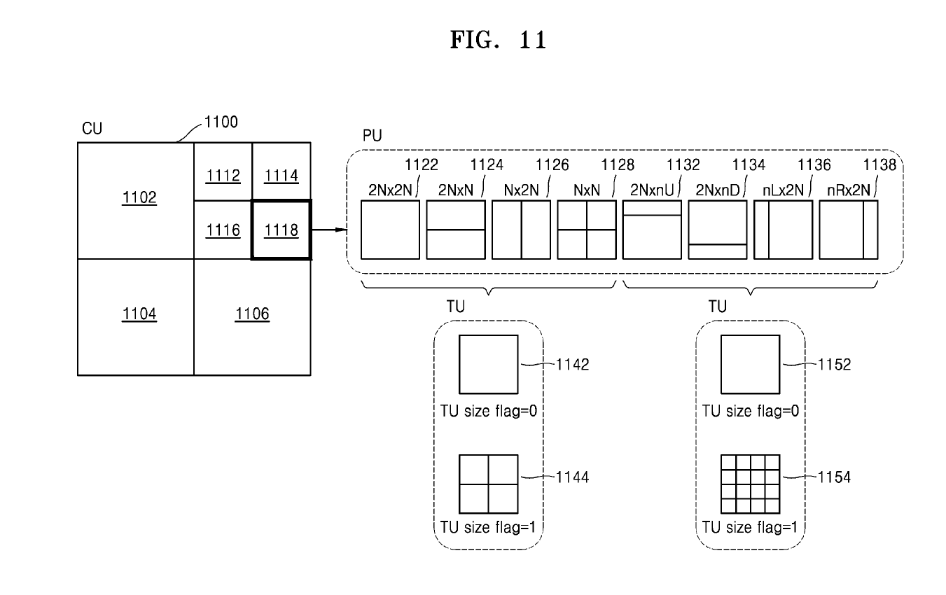

FIG. 11 illustrates a relationship between a coding unit, a prediction unit, and a transformation unit, according to encoding mode information of Table 1.

A largest coding unit 1100 includes coding units 1102, 1104, 1106, 1112, 1114, 1116, and 1118 of coded depths. Here, since the coding unit 1118 is a coding unit of a coded depth, split information may be set to 0. Partition type information of the coding unit 1318 having a size of 2N×2N may be set to be one of partition types including 2N×2N 1122, 2N×N 1124, N×2N 1126, N×N 1128, 2N×nU 1132, 2N×nD 1134, nL×2N 1136, and nR×2N 1138.

Transformation unit split information (TU size flag) is a type of a transformation index, and a size of a transformation unit corresponding to the transformation index may be changed according to a prediction unit type or partition type of the coding unit.

For example, when the partition mode information is set to be one of symmetrical partition types 2N×2N 1122, 2N×N 1124, N×2N 1126, and N×N 1128, if the transformation unit split information is 0, a transformation unit 1142 having a size of 2N×2N is set, and if the transformation unit split information is 1, a transformation unit 1144 having a size of N×N may be set.

When the partition type information is set to be one of asymmetrical partition types 2N×nU 1132, 2N×nD 1134, nL×2N 1136, and nR×2N 1138, if the transformation unit split information (TU size flag) is 0, a transformation unit 1152 having a size of 2N×2N may be set, and if the transformation unit split information is 1,a transformation unit 1354 having a size of N/2×N/2 may be set.

The transformation unit split information (TU size flag) described above with reference to FIG. 5 is a flag having a value or 0 or 1, but the transformation unit split information according to an embodiment is not limited to a flag having 1 bit, and the transformation unit may be hierarchically split while the transformation unit split information increases in a manner of 0, 1, 2, 3. etc., according to setting. The transformation unit split information may be an example of the transformation index.

In this case, the size of a transformation unit that has been actually used may be expressed by using the transformation unit split information according to the embodiment, together with a maximum size of the transformation unit and a minimum size of the transformation unit. The video encoding apparatus 100 according to the embodiment may encode maximum transformation unit size information, minimum transformation unit size information, and maximum transformation unit split information. The result of encoding the maximum transformation unit size information, the minimum transformation unit size information, and the maximum transformation unit split information may be inserted into an SPS. The video decoding apparatus 150 according to the embodiment may decode video by using the maximum transformation unit size information, the minimum transformation unit size information, and the maximum transformation unit split information.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b-1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit may be defined by Equation (1):

CurrMinTuSize

=max (MinTransformSize, RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit

According to an embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize =min(MaxTransformSize, PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize =min(MaxTransformSize, PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an embodiment, and a factor for determining the current maximum transformation unit size is not limited thereto.

According to the video encoding method based on coding units having a tree structure described above with reference to FIGS. 8 through 11, image data of a spatial domain is encoded in each of the coding units having a tree structure, and the image data of the spatial domain is reconstructed in a manner that decoding is performed on each largest coding unit according to the video decoding method based on the coding units having a tree structure, so that a video that is formed of pictures and pictures sequences may be reconstructed. The reconstructed video may be reproduced by a reproducing apparatus, may be stored in a storage medium, or may be transmitted via a network.

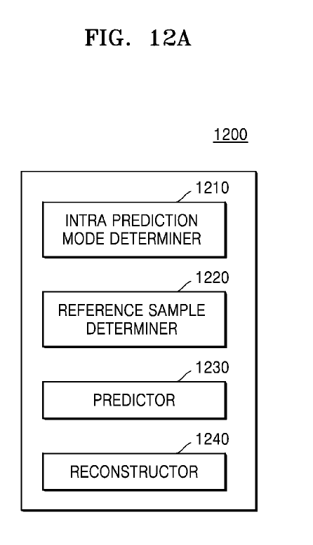

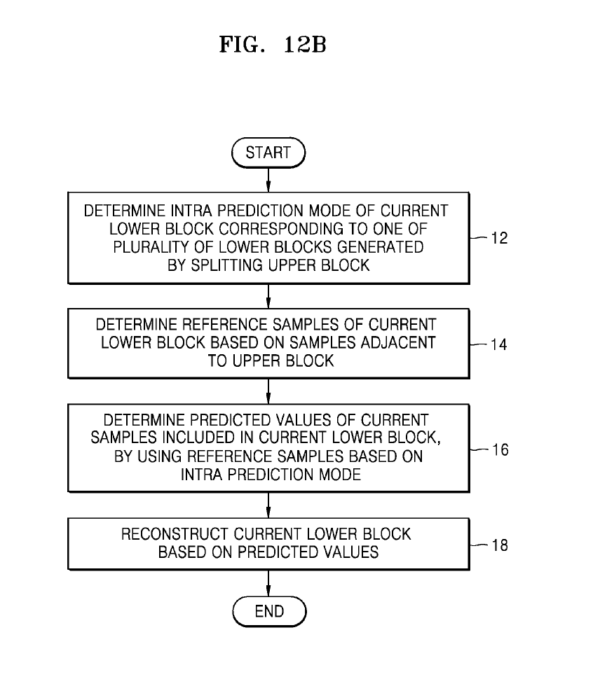

FIG. 12A is a block diagram of a video decoding apparatus 1200 according to an embodiment. Specifically, the block diagram of FIG. 12A shows an embodiment of a video decoding apparatus using an intra prediction mode.

The video decoding apparatus 1200 may include an intra prediction mode determiner 1210, a reference sample determiner 1220, a predictor 1230, and a reconstructor 1240. Although the intra prediction mode determiner 1210, the reference sample determiner 1220, the predictor 1230, and the reconstructor 1240 are illustrated as separate elements in FIG. 12A, according to another embodiment, the intra prediction mode determiner 1210, the reference sample determiner 1220, the predictor 1230, and the reconstructor 1240 may be combined into a single element. According to another embodiment, the functions of the intra prediction mode determiner 1210, the reference sample determiner 1220, the predictor 1230, and the reconstructor 1240 may be performed by two or more elements.

Although the intra prediction mode determiner 1210, the reference sample determiner 1220, the predictor 1230, and the reconstructor 1240 are illustrated as elements of one apparatus in FIG. 12A, apparatuses for performing the functions of the intra prediction mode determiner 1210, the reference sample determiner 1220, the predictor 1230, and the reconstructor 1240 do not always need to be physically adjacent to each other. Therefore, according to another embodiment, the intra prediction mode determiner 1210, the reference sample determiner 1220, the predictor 1230, and the reconstructor 1240 may be distributed.

The intra prediction mode determiner 1210, the reference sample determiner 1220, the predictor 1230, and the reconstructor 1240 of FIG. 12A may be controlled by a single processor according to an embodiment, or by multiple processors according to another embodiment.

The video decoding apparatus 1200 may include a storage (not shown) for storing data generated by the intra prediction mode determiner 1210, the reference sample determiner 1220, the predictor 1230, and the reconstructor 1240.

The intra prediction mode determiner 1210, the reference sample determiner 1220, the predictor 1230, and the reconstructor 1240 may extract the data from the storage and use the data.

The video decoding apparatus 1200 of FIG. 12A is not limited to a physical apparatus. For example, a part of the functions of the video decoding apparatus 1200 may be performed by software instead of hardware.

The intra prediction mode determiner 1210 determines an intra prediction mode of a current lower block corresponding to one of a plurality of lower blocks generated by splitting an upper block.

The concepts of upper and lower blocks are relative. An upper block may include a plurality of lower blocks. For example, the upper block may be a coding unit, and the lower blocks may be prediction units included in the coding unit. As another example, the upper block may be a largest coding unit, and the lower blocks may be prediction units included in a coding unit.

The current lower block represents a lower block to be currently decoded among the lower blocks included in the upper block. The intra prediction mode of the current lower block may be determined based on intra prediction mode information obtained from a bitstream.

The reference sample determiner 1220 determines reference samples of the current lower block based on samples adjacent to the upper block.

In an inter prediction mode, predicted values of samples included in a prediction unit are determined from another image. Thus, prediction units and transformation units included in a coding unit do not have dependency therebetween. Accordingly, the prediction units and the transformation units included in the coding unit may be encoded and decoded independently of and in parallel with each other.

However, in the intra prediction mode, a coding unit is encoded and decoded based on continuity with samples adjacent thereto. Accordingly, in the intra prediction mode, the closer samples to be decoded and reference samples used for intra prediction are, the more accurately prediction may be performed.

Reference samples used for intra prediction may be determined using various methods. According to a first intra prediction method, samples adjacent to a prediction unit are determined as reference samples, and predicted values of samples included in the prediction unit are determined based on the reference samples. According to a second intra prediction method, samples adjacent to a coding unit are determined as reference samples, and predicted values of samples included in a prediction unit are determined based on the reference samples.

According to the first intra prediction method, to increase accuracy of the predicted values, intra prediction and reconstruction are performed based on a transformation unit equal to or smaller than the prediction unit. If the transformation unit is smaller than the prediction unit, samples adjacent to the transformation unit are determined as the reference samples, and predicted values of samples included in the transformation unit are determined based on the reference samples.

If the transformation unit is larger than the prediction unit, since decoding is performed based on the transformation unit, samples adjacent to some prediction units are not reconstructed and thus samples of the prediction units are not predicted. Therefore, according to the first intra prediction method, the prediction unit should always be larger than the transformation unit.

According to the second intra prediction method, although accuracy of predicted values is slightly reduced compared to the first intra prediction method, since dependency between prediction units is removed, prediction units may be predicted in parallel with each other. In addition, although the first intra prediction method restricts that the transformation unit should not be larger than the prediction unit, according to the second intra prediction method, since the prediction unit always refers to already reconstructed samples, the prediction unit may be smaller than the transformation unit. Therefore, according to the second intra prediction method, one transformation unit may include a plurality of prediction units.

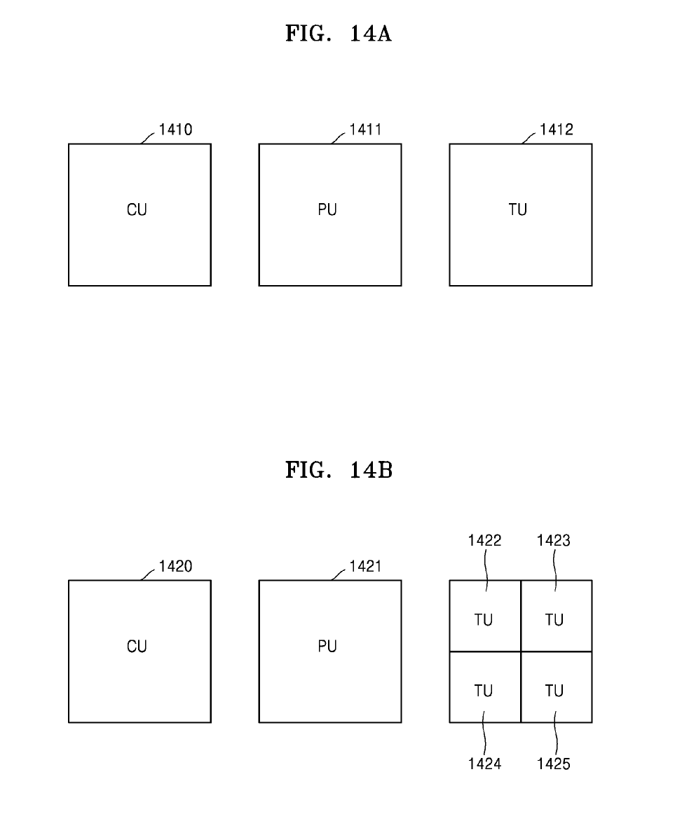

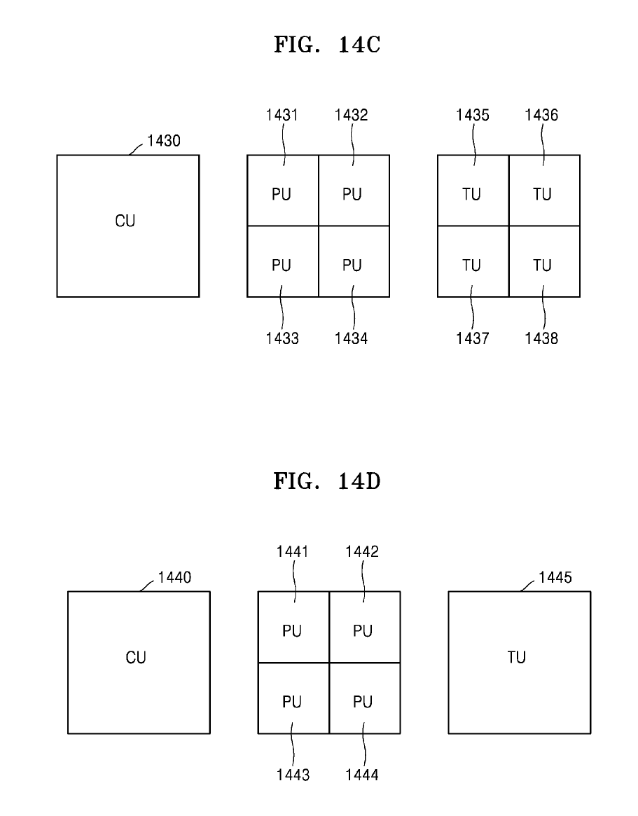

The above-described first and second intra prediction methods will be described in detail below with reference to FIGS. 14A to 14D.

The first intra prediction method has a problem that the transformation unit may be predicted depending on another transformation unit included in the coding unit. Accordingly, transformation units may not be encoded and decoded independently of and in parallel with each other. In addition, when the prediction unit is smaller than the transformation unit, spatial correlation between reference samples and samples included in the prediction unit is reduced based on the location on the prediction unit.

Accordingly, a partition type of the prediction unit for calculating predicted values of the samples, and the size of the transformation unit for calculating residual data of the samples are determined depending on each other. In addition, prediction units are predicted depending on each other, and thus are not predicted in parallel with each other.

The above-described problems will be described in detail below with reference to FIGS. 14A to 14D.

To solve the above-described problems, similarly to the second intra prediction method, the reference samples of the current lower block may be determined based on the samples adjacent to the upper block including the lower blocks. Since the lower blocks included in the upper block share the samples adjacent to the upper block, the lower block does not refer to reconstructed samples of another lower block for intra prediction. In other words, current samples included in the current lower block are excluded from reference samples of another lower block included in the upper block. Therefore, the lower blocks may be intra-predicted independently of each other. Accordingly, the lower blocks may be predicted in parallel with each other, and the partition type of the prediction unit and the size of the transformation unit may be determined independently of each other.

For example, when the upper block is a coding unit and the lower blocks are prediction units included in the coding unit, predicted values of samples included in the prediction unit may be determined based on samples adjacent to the coding unit including the prediction unit.

As another example, when the upper block is a largest coding unit and the lower block is a prediction unit of a coding unit included in the upper block, predicted values of samples included in the prediction unit may be determined based on samples adjacent to the largest coding unit including the prediction unit.

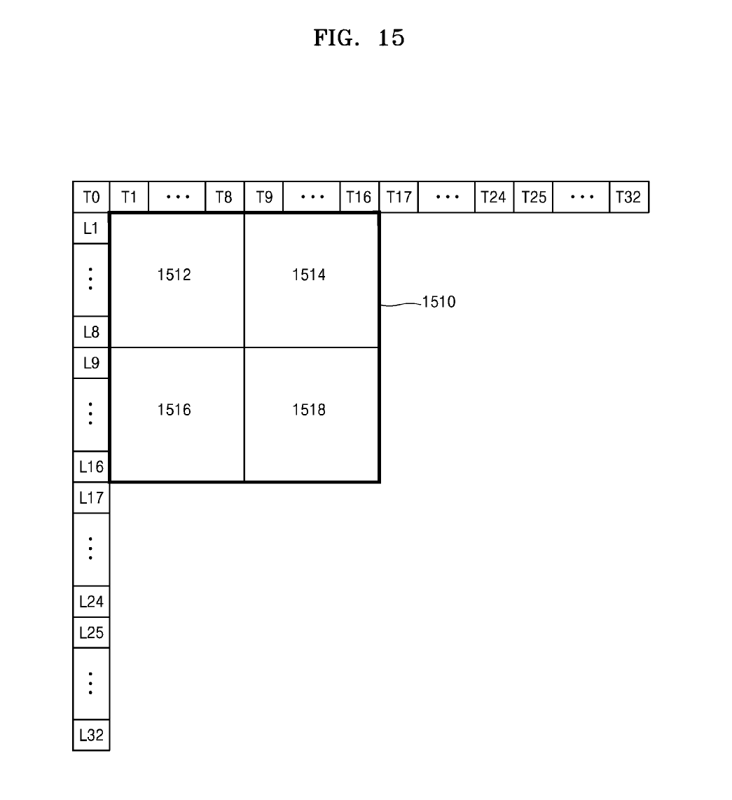

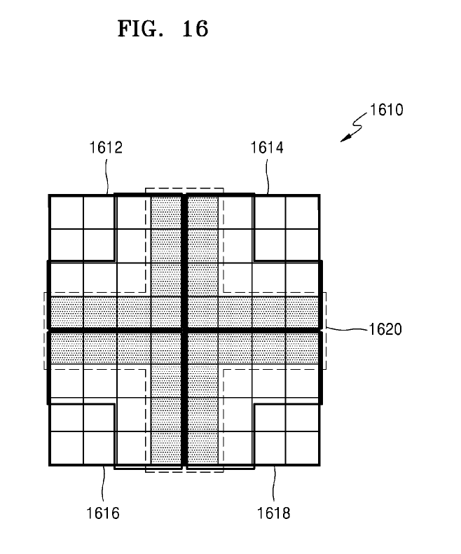

Reference samples of the lower block may be determined using various methods based on the samples adjacent to the upper block. For example, all samples adjacent to the upper block may be determined as the reference samples of the lower block. As another example, samples located in a horizontal direction of the current lower block and samples located in a vertical direction of the current lower block among the samples adjacent to the upper block may be determined as the reference samples. The reference sample determination method will be described in detail below with reference to FIGS. 15 and 16.

The reference sample determiner 1220 may determine the reference sample determination method based on an upper block boundary intra prediction flag indicating whether the reference samples are determined based on the samples adjacent to the upper block. For example, when the upper block boundary intra prediction flag indicates that the reference samples are determined based on the samples adjacent to the upper block, the reference samples may be determined based on the samples adjacent to the upper block. On the contrary, when the upper block boundary intra prediction flag does not indicate that the reference samples are determined based on the samples adjacent to the upper block, the reference samples may be determined using another method. For example, the reference samples may be determined based on samples adjacent to the lower block.

The upper block boundary intra prediction flag with respect to upper video data of the upper block may be obtained from the bitstream. For example, the upper block boundary intra prediction flag may be obtained per an image. When the upper block boundary intra prediction flag indicates that the reference samples are determined based on the samples adjacent to the upper block, reference samples of all lower blocks of the image are determined based on the samples adjacent to the upper block.

As another example, the upper block boundary intra prediction flag may be obtained per a sequence unit including a plurality of images. When the upper block boundary intra prediction flag indicates that the reference samples are determined based on the samples adjacent to the upper block, reference samples of all lower blocks included in the sequence unit are determined based on the samples adjacent to the upper block.

The predictor 1230 determines predicted values of the current samples included in the current lower block, by using the reference samples determined by the reference sample determiner 1220, based on the intra prediction mode.

The current samples represent samples included in the current lower block to be currently decoded. The predicted values of the current samples may be determined based on a prediction scheme indicated by the intra prediction mode. The reference sample determination method will be described in detail below with reference to FIGS. 15 and 16.

A boundary filter (not shown) may apply a smoothing filter to samples adjacent to boundaries between the predicted current lower block and other predicted lower blocks included in the upper block. The function of the boundary filter will be described in detail below with reference to FIG. 17.

The reconstructor 1240 reconstructs the current lower block based on the predicted values determined by the predictor 1230. The predicted values of the current samples included in the current lower block are summed up with residual data corresponding to the current samples. The summed values serve as reconstructed values of the current samples.

The functions of the intra prediction mode determiner 1210, the reference sample determiner 1220, the predictor 1230, and the reconstructor 1240 may be performed on all lower blocks included in the upper block. All lower blocks share the reference samples for intra prediction, and thus may be intra-predicted and decoded independently of and in parallel with each other.

FIG. 12B is a flowchart of a video decoding method 1250 according to an embodiment. Specifically, the flowchart of FIG. 12B shows an embodiment of a video decoding method using an intra prediction method.

In operation 12, an intra prediction mode of a current lower block corresponding to one of a plurality of lower blocks generated by splitting an upper block is determined. According to an embodiment, the upper block may be a coding unit, and the lower blocks may be prediction units included in the coding unit.

In operation 14, reference samples of the current lower block are determined based on samples adjacent to the upper block. According to an embodiment, all samples adjacent to the upper block may be determined as the reference samples of the lower block. According to another embodiment, samples located in a horizontal direction of the current lower block and samples located in a vertical direction of the current lower block among the samples adjacent to the upper block may be determined as the reference samples.

Before operation 14, an upper block boundary intra prediction flag may be obtained from a bitstream. When the upper block boundary intra prediction flag indicates that the reference samples are determined as the samples adjacent to the upper block, the reference samples of the current lower block may be determined based on the samples adjacent to the upper block. The upper block boundary intra prediction flag may be obtained with respect to upper video data of the upper block.

In operation 16, predicted values of current samples included in the current lower block are determined using the reference samples based on the intra prediction mode. A smoothing filter may be applied to samples adjacent to boundaries between the predicted current lower block and other predicted lower blocks included in the upper block.

In operation 18, the current lower block is reconstructed based on the predicted values.

The upper block may be predicted and reconstructed by performing operations 12 to 18 on all lower blocks included in the upper block. All lower blocks included in the upper block may be intra-predicted and reconstructed independently of and in parallel with each other.

The above-described video decoding method 1250 according to an embodiment may be performed by the video decoding apparatus 1200.

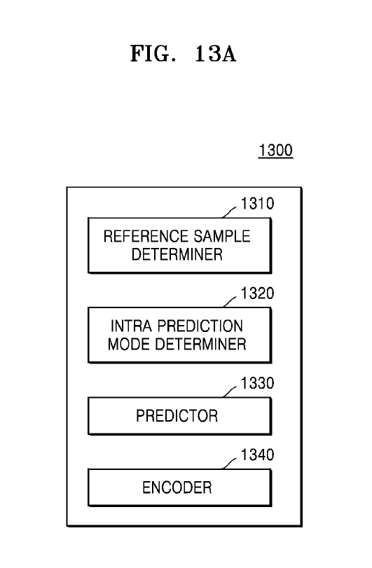

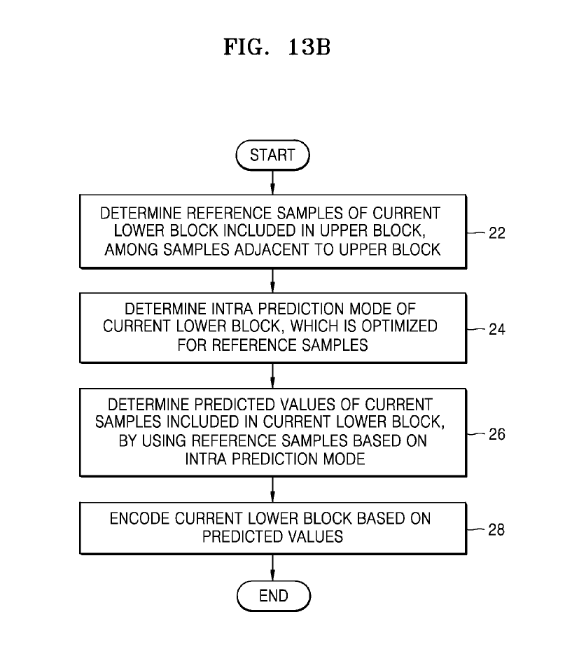

FIG. 13A is a block diagram of a video encoding apparatus 1300 according to an embodiment. Specifically, the block diagram of FIG. 13A shows an embodiment of a video encoding apparatus using an intra prediction mode.

The video encoding apparatus 1300 may include a reference sample determiner 1310, an intra prediction mode determiner 1320, a predictor 1330, and an encoder 1340. Although the reference sample determiner 1310, the intra prediction mode determiner 1320, the predictor 1330, and the encoder 1340 are illustrated as separate elements in FIG. 13A, according to another embodiment, the reference sample determiner 1310, the intra prediction mode determiner 1320, the predictor 1330, and the encoder 1340 may be combined into a single element. According to another embodiment, the functions of the reference sample determiner 1310, the intra prediction mode determiner 1320, the predictor 1330, and the encoder 1340 may be performed by two or more elements.

Although the reference sample determiner 1310, the intra prediction mode determiner 1320, the predictor 1330, and the encoder 1340 are illustrated as elements of one apparatus in FIG. 13A, apparatuses for performing the functions of the reference sample determiner 1310, the intra prediction mode determiner 1320, the predictor 1330, and the encoder 1340 do not always need to be physically adjacent to each other. Therefore, according to another embodiment, the reference sample determiner 1310, the intra prediction mode determiner 1320, the predictor 1330, and the encoder 1340 may be distributed.

The reference sample determiner 1310, the intra prediction mode determiner 1320, the predictor 1330, and the encoder 1340 of FIG. 13A may be controlled by a single processor according to an embodiment, or by multiple processors according to another embodiment.

The video encoding apparatus 1300 may include a storage (not shown) for storing data generated by the reference sample determiner 1310, the intra prediction mode determiner 1320, the predictor 1330, and the encoder 1340. The reference sample determiner 1310, the intra prediction mode determiner 1320, the predictor 1330, and the encoder 1340 may extract the data from the storage and use the data.

The video encoding apparatus 1300 of FIG. 13A is not limited to a physical apparatus. For example, a part of the functions of the video encoding apparatus 1300 may be performed by software instead of hardware.

The reference sample determiner 1310 determines reference samples of a current lower block included in an upper block, among samples adjacent to the upper block. According to an embodiment, the upper block may be a coding unit, and lower blocks may be prediction units included in the coding unit.

According to an embodiment, the reference sample determiner 1310 may determine all samples adjacent to the upper block, as the reference samples. According to another embodiment, the reference sample determiner 1310 may determine samples located in a horizontal direction of the current lower block and samples located in a vertical direction of the current lower block among the samples adjacent to the upper block, as the reference samples.

When an upper block boundary intra prediction flag indicating whether the reference samples are determined based on the samples adjacent to the upper block indicates that the reference samples are determined as the samples adjacent to the upper block, the reference sample determiner 1310 may determine the samples adjacent to the upper block, as the reference samples of the current lower block. The upper block boundary intra prediction flag may be determined with respect to upper video data of the upper block.

The intra prediction mode determiner 1320 determines an intra prediction mode of the current lower block, which is optimized for the reference samples. The intra prediction mode of the lower block may be determined as the most efficient intra prediction mode based on rate-distortion optimization.

The predictor 1330 determines predicted values of current samples included in the current lower block, by using the reference samples based on the intra prediction mode. The predictor 1330 may apply a smoothing filter to samples adjacent to boundaries between the predicted current lower block and other predicted lower blocks included in the upper block.

The encoder 1340 encodes the current lower block based on the predicted values. The encoder 1340 may generate residual data including difference values between original values and the predicted values of the current samples. The encoder 1340 may include encoding information determined by the reference sample determiner 1310, the intra prediction mode determiner 1320, and the predictor 1330, in a bitstream.

The functions of the reference sample determiner 1310, the intra prediction mode determiner 1320, the predictor 1330, and the encoder 1340 may be performed on all lower blocks included in the upper block. All lower blocks included in the upper block may be predicted and encoded independently of and in parallel with each other.

FIG. 13B is a flowchart of a video encoding method 1350 according to an embodiment. Specifically, the flowchart of FIG. 13B shows an embodiment of a video encoding method using an intra prediction method.

In operation 22, reference samples of a current lower block are determined based on samples adjacent to an upper block. According to an embodiment, all samples adjacent to the upper block may be determined as the reference samples of the lower block. According to another embodiment, samples located in a horizontal direction of the current lower block and samples located in a vertical direction of the current lower block among the samples adjacent to the upper block may be determined as the reference samples.

According to an embodiment, the upper block may be a coding unit, and lower blocks may be prediction units included in the coding unit. According to another embodiment, the lower blocks may be prediction units included in a coding unit, and the upper block may be a largest coding unit including the lower blocks.

Before operation 22, it may be determined whether the reference samples are determined based on the samples adjacent to the upper block. The reference sample determination method may be determined with respect to upper video data of the upper block. An upper block boundary intra prediction flag is generated based on the reference sample determination method.

In operation 24, an intra prediction mode of the current lower block corresponding to one of a plurality of lower blocks generated by splitting the upper block is determined. The intra prediction mode of the lower block may be determined as the most efficient intra prediction mode based on rate-distortion optimization.

In operation 26, predicted values of current samples included in the current lower block are determined using the reference samples based on the intra prediction mode. A smoothing filter may be applied to samples adjacent to boundaries between the predicted current lower block and other predicted lower blocks included in the upper block.

In operation 28, the current lower block is encoded based on the predicted values.

The upper block may be predicted and encoded by performing operations 22 to 28 on all lower blocks included in the upper block. All lower blocks included in the upper block may be predicted and encoded independently of and in parallel with each other.

The above-described video encoding method 1350 according to an embodiment may be performed by the video encoding apparatus 1300.

FIGS. 14A to 14D are diagrams for describing differences between the first intra prediction method and the second intra prediction method. In FIGS. 14A to 14D, CU denotes a coding unit, PU denotes a prediction unit, and TU denotes a transformation unit.

FIG. 14A shows a case in which a coding unit 1410, a prediction unit 1411, and a transformation unit 1412 have the same size. Since the coding unit 1410, the prediction unit 1411, and the transformation unit 1412 are the same, samples adjacent to the coding unit 1410 are the same as samples adjacent to the prediction unit 1411 and the transformation unit 1412. Accordingly, reference samples determined using the first intra prediction method are the same as reference samples determined using the second intra prediction method. Therefore, predicted values do not differ based on the intra prediction method.

FIG. 14B shows a case in which a coding unit 1420 and a prediction unit 1421 have the same size but transformation units 1422, 1423, 1424, and 1425 have a size of N×N.

According to the first intra prediction method, samples are predicted and decoded based on a transformation unit. Since the prediction unit 1421 includes the transformation units 1422, 1423, 1424, and 1425, the transformation units 1422, 1423, 1424, and 1425 have the same intra prediction mode. However, each of the transformation units 1422, 1423, 1424, and 1425 is intra-predicted with reference to samples adjacent thereto. For example, when prediction and decoding are performed in a Z scan direction, prediction and decoding are performed in the order of the transformation unit 1422, the transformation unit 1423, the transformation unit 1424, and the transformation unit 1425. Thus, the transformation unit 1423 is intra-predicted with reference to samples of the transformation unit 1422.

According to the second intra prediction method, the prediction unit 1421 is predicted based on blocks adjacent to the prediction unit 1421. The transformation units 1422, 1423, 1424, and 1425 generate residual data independently of each other. Since the first and second intra prediction methods use different reference samples for intra prediction, predicted values of samples and residual data differ between the first and second intra prediction methods.

FIG. 14C shows a case in which prediction units 1431, 1432, 1433, and 1434 and transformation units 1435, 1436, 1437, and 1438 have a size of N×N.

According to the first intra prediction method, samples are predicted and decoded based on a transformation unit. The transformation units 1435, 1436, 1437, and 1438 are predicted based on intra prediction modes of the prediction units 1431, 1432, 1433, and 1434 corresponding thereto. Each of the transformation units 1435, 1436, 1437, and 1438 is intra-predicted with reference to samples adjacent thereto. For example, when prediction and decoding are performed in a Z direction, prediction and decoding are performed in the order of the transformation unit 1435, the transformation unit 1436, the transformation unit 1437, and the transformation unit 1438. Thus, the transformation unit 1436 is intra-predicted with reference to samples of the transformation unit 1437.

According to the second intra prediction method, the prediction units 1431, 1432, 1433, and 1434 are predicted based on samples adjacent to a coding unit 1430. The transformation units 1435, 1436, 1437, and 1438 generate residual data independently of each other. Like the embodiment of FIG. 14B, since the first and second intra prediction methods use different reference samples for intra prediction, predicted values of samples and residual data differ between the first and second intra prediction methods.

FIG. 14D shows a case in which a coding unit 1440 and a transformation unit 1445 have the same size but prediction units 1441, 1442, 1443, and 1444 have a size of N×N.

According to the first intra prediction method, intra prediction may not be performed on all of the four prediction units 1441, 1442, 1443, and 1444 included in the transformation unit 1445. According to the first intra prediction method, since all samples are intra-predicted and decoded based on a transformation unit, samples corresponding to the prediction unit 1441 may be decoded but the prediction units 1442, 1443, and 1444 are not predicted because samples adjacent thereto are not decoded. For example, although the prediction unit 1442 is predictable after samples of the prediction unit 1441 are decoded, since all samples of the transformation unit 1445 are simultaneously predicted and decoded, the prediction unit 1442 is not predicted. Consequently, the first intra prediction method is not applicable to FIG. 14D.

However, according to the second intra prediction method, since the prediction units 1441, 1442, 1443, and 1444 are predicted based on samples adjacent to the coding unit 1440, all samples of the transformation unit 1445 may be predicted in parallel with each other. Thus, unlike the first intra prediction method, prediction and decoding may be performed even when a transformation unit is larger than a prediction unit.

To sum up the descriptions of FIGS. 14A to 14D, according to the second intra prediction method, unlike the first intra prediction method, prediction and decoding may be performed even when a transformation unit is larger than a prediction unit. Transformation units may be intra-predicted and decoded in a scan order of the transformation units according to the first intra prediction method, but prediction units may be predicted and transformation units may generate residual data independently of and in parallel with each other according to the second intra prediction method.

In the cases of FIGS. 14B and 14C, the first intra prediction method for determining relatively close samples as reference samples may be more efficient than the second intra prediction method. However, a high-resolution image has a high possibility that continuity is maintained between reference samples spaced apart from a prediction unit and samples included in the prediction unit, and thus may use the second intra prediction method.

FIG. 15 shows an embodiment of the second intra prediction method.

FIG. 15 illustrates a coding unit 1510 having a size of 16×16. The coding unit 1510 includes four prediction units 1512, 1514, 1516, and 1518. Already decoded samples T0 to T32, and L1 to L32 are located adjacent to the coding unit 1510. Decoded samples among T0 to T32, and L1 to L32 may be determined as reference samples used to predict the prediction units 1512, 1514, 1516, and 1518.

Not-decoded samples among T0 to T32, and L1 to L32 are determined to have the closest decoded sample value only in a prediction process of the coding unit 1510. For example, when L16 is decoded and L17 to L32 are not decoded, L17 to L32 are regarded to have the same value as the closest decoded sample value L16 only in a prediction process of the coding unit 1510.

The four prediction units 1512, 1514, 1516, and 1518 have different intra prediction modes. In FIG. 15, the prediction unit 1512 is predicted in a vertical mode, the prediction unit 1514 is predicted in a diagonal down-left mode, the prediction unit 1516 is predicted in a DC mode, and the prediction unit 1518 is predicted in a diagonal down-right mode. The prediction units 1512, 1514, 1516, and 1518 are predicted based on reference samples located outside the coding unit 1510, e.g., T0 to T32, and L1 to L32. Samples located in the coding unit 1510 are not used to predict the prediction units 1512, 1514, 1516, and 1518.

The prediction unit 1512 is predicted in a vertical mode. Accordingly, the reference samples T1 to T8 located in a top direction of the prediction unit 1512 are used to predict the prediction unit 1512. Samples included in the prediction unit 1512 have predicted values equal to the values of reference samples located in vertical directions of the samples. For example, when the value of T1 is 64, predicted values of samples located in the same column as T1 are determined to be 64.

The prediction unit 1514 is predicted in a diagonal down-left mode. Accordingly, the reference samples T10 to T24 located in a top right direction of the prediction unit 1514 are used to predict the prediction unit 1514. Samples included in the prediction unit 1514 have predicted values equal to the values of reference samples located in top right directions of the samples. For example, when the value of T17 is 96, predicted values of samples located in a bottom left direction of T1 are determined to be 96.

The prediction unit 1516 is predicted in a DC mode. Accordingly, the reference samples T0 to T16, and L1 to L16 adjacent to the prediction unit 1516 are used to predict the prediction unit 1516. Samples included in the prediction unit 1516 have predicted values equal to an average value of the reference samples T0 to T16, and L1 to L16. For example, when the average value of the reference samples T0 to T16 is 80, the predicted values of the samples included in the prediction unit 1516 are all determined to be 80.

The prediction unit 1518 is predicted in a diagonal down-right mode. Accordingly, the reference samples T0 to T7, and L1 to L7 located in a top left direction of the prediction unit 1518 are used to predict the prediction unit 1518. Samples included in the prediction unit 1518 have predicted values equal to the values of reference samples located in top left directions of the samples. For example, when the value of T0 is 64, predicted values of samples located in a bottom right direction of T0 are determined to be 64

According to another embodiment, the reference samples of the prediction units 1512, 1514, 1516, and 1518 may be determined based on the locations thereof. The reference samples may include samples located in a horizontal direction of each prediction unit and samples located in a vertical direction of the prediction unit among samples adjacent to the coding unit 1510. In addition, the reference samples may include samples located in a top right direction of the prediction unit and samples located in a bottom left direction of the prediction unit. If necessary, the reference samples may further include the samples adjacent to the coding unit 1510.

For example, the reference samples of the prediction unit 1512 may include the samples T0 to T8 located in a vertical direction of the prediction unit 1512 and the samples L1 to L8 located in a horizontal direction of the prediction unit 1512. The reference samples of the prediction unit 1512 may further include the samples T9 to T16 located in a top right direction of the prediction unit 1512 and the samples L9 to L16 located in a bottom left direction of the prediction unit 1512. Since the prediction unit 1512 is predicted in a vertical mode, the prediction unit 1512 is predicted based on the reference samples T1 to T8.

For example, the reference samples of the prediction unit 1514 may include the samples T9 to T16 located in a vertical direction of the prediction unit 1514 and the samples L1 to L8 located in a horizontal direction of the prediction unit 1514. The reference samples of the prediction unit 1514 may further include the samples T17 to T24 located in a top right direction of the prediction unit 1514 and the samples L17 to L24 located in a bottom left direction of the prediction unit 1514. Since the prediction unit 1514 is predicted in a diagonal down-left mode, the prediction unit 1514 is predicted based on the reference samples T10 to T24.

For example, the reference samples of the prediction unit 1516 may include the samples T0 to T8 located in a vertical direction of the prediction unit 1516 and the samples L9 to L16 located in a horizontal direction of the prediction unit 1516. The reference samples of the prediction unit 1516 may further include the samples T17 to T24 located in a top right direction of the prediction unit 1516 and the samples L17 to L24 located in a bottom left direction of the prediction unit 1516. Since the prediction unit 1516 is predicted in a DC mode, the prediction unit 1516 is predicted based on an average value of the reference samples L9 to L16, and T0 to T8.

For example, the reference samples of the prediction unit 1518 may include the samples T9 to T16 located in a vertical direction of the prediction unit 1518 and the samples L9 to L16 located in a horizontal direction of the prediction unit 1518. The reference samples of the prediction unit 1518 may further include the samples T25 to T32 located in a top right direction of the prediction unit 1518 and the samples L25 to L32 located in a bottom left direction of the prediction unit 1518. Since the prediction unit 1518 is predicted in a diagonal down-right mode, the prediction unit 1518 is predicted based on the reference samples T9 to T16, and L9 to L16.

If necessary, the reference samples of the prediction units 1512, 1514, 1516, and 1518 may include samples adjacent to the coding unit 1510.

FIG. 16 is a diagram for describing a smoothing filter applied to boundaries of prediction units. FIG. 16 shows an embodiment of an intra prediction method for applying a smoothing filter to boundaries of prediction units after the prediction units are predicted.

A coding unit 1610 includes four prediction units 1612, 1614, 1616, and 1618. Since the prediction units 1612, 1614, 1616, and 1618 are predicted in different intra prediction modes, continuity of samples located at boundaries of the prediction units 1612, 1614, 1616, and 1618 is low. Accordingly, a smoothing filter may be applied to the samples located at the boundaries of the prediction units 1612, 1614, 1616, and 1618, thereby increasing continuity between the samples.

The smoothing filter may be applied using various methods based on three conditions. First, the smoothing filter may be differently applied based on to how far samples from the boundaries the smoothing filter is applied. For example, the smoothing filter may be applied to only samples right next to the boundaries. As another example, the smoothing filter may be applied to samples from samples right next to the boundaries to samples far from the boundaries by two sample units. As another example, the range of samples to which the smoothing filter is applied may be determined based on the size of the prediction units 1612, 1614, 1616, and 1618.

Second, the smoothing filter may be differently applied based on the number of taps of a used filter. For example, when a 3-tap filter is used, a sample to which the smoothing filter is applied is filtered based on a left sample and a right sample thereof. As another example, when a 5-tap filter is used, a sample to which the smoothing filter is applied is filtered based on two left samples and two right samples thereof.

Third, the smoothing filter may be differently applied based on filter coefficients of a used filter. When a 3-tap filter is used, the filter coefficients may be determined to be [a1, a2, a3]. If a2 is greater than a1 and a3, the intensity of filtering is reduced. When a 5-tap filter is used, the filter coefficients may be determined to be [a1, a2, a3, a4, a5]. If a3 is greater than a1, a2, a4, and a5, the intensity of filtering is reduced. For example, the filtering intensity of a 5-tap filter having filter coefficients of [1, 4, 6, 4, 1] is higher than the filtering intensity of a 5-tap filter having filter coefficients of [1, 2, 10, 2, 1].

According to the embodiment 1600 of FIG. 16, the smoothing filter is applied to samples 1620 adjacent to the boundaries of the prediction units 1612, 1614, 1616, and 1618. Since the smoothing filter is applied to the samples 1620, continuity of samples included in the coding unit 1610 is increased.

The one or more embodiments may be written as computer programs and may be implemented in general-use digital computers that execute the programs by using a non-transitory computer-readable recording medium. Examples of the non-transitory computer-readable recording medium include magnetic storage media (e.g., ROM, floppy disks, hard disks, etc.), optical recording media (e.g., CD-ROMs, or DVDs), etc.

While the present invention has been particularly shown and described with reference to embodiments thereof, it will be understood by one of ordinary skill in the art that various changes in form and details may be made therein without departing from the spirit and scope of the following claims. The embodiments should be considered in a descriptive sense only and not for purposes of limitation. Therefore, the scope of the invention is defined not by the detailed description but by the following claims, and all differences within the scope will be construed as being included in the present invention.

1. A video decoding method comprising:
determining an intra prediction mode of a current lower block corresponding to one of a plurality of lower blocks generated by splitting an upper block;
determining reference samples of the current lower block based on samples adjacent to the upper block;
determining a predicted value of a current sample comprised in the current lower block, by using the reference samples based on the intra prediction mode; and
reconstructing the current lower block based on the predicted value,
wherein the current sample comprised in the current lower block is excluded from reference samples of another lower block comprised in the upper block.

2. The video decoding method of claim 1, wherein the upper block is a coding unit, and
wherein the plurality of lower blocks are prediction units comprised in the coding unit.

3. The video decoding method of claim 1, wherein the determining of the reference samples comprises determining all samples adjacent to the upper block, as the reference samples.

4. The video decoding method of claim 1, wherein the determining of the reference samples comprises determining samples located in a horizontal direction of the current lower block and samples located in a vertical direction of the current lower block among the samples adjacent to the upper block, as the reference samples.

5. The video decoding method of claim 1, further comprising obtaining an upper block boundary intra prediction flag indicating whether the reference samples are determined based on the samples adjacent to the upper block,
wherein the determining of the reference samples comprises determining the samples adjacent to the upper block, as the reference samples of the current lower block if the upper block boundary intra prediction flag indicates that the reference samples are determined as the samples adjacent to the upper block.

6. The video decoding method of claim 4, wherein the obtaining of the upper block boundary intra prediction flag comprises obtaining the upper block boundary intra prediction flag with respect to the upper block or upper video data of the upper block.

7. The video decoding method of claim 1, wherein the upper block is predicted by performing the determining of the intra prediction mode, the determining of the reference samples, and the determining of the predicted value on all lower blocks comprised in the upper block.

8. The video decoding method of claim 1, wherein the current lower block and other lower blocks comprised in the upper block are predicted and reconstructed in parallel with each other.

9. The video decoding method of claim 1, further comprising applying a smoothing filter to samples adjacent to boundaries between the predicted current lower block and other predicted lower blocks comprised in the upper block.

10. The video decoding method of claim 1, wherein the reconstructing of the current lower block comprises obtaining residual data from one transformation unit comprising the plurality of lower blocks.

11. A video decoding apparatus comprising an intra prediction mode determiner configured to determine an intra prediction mode of a current lower block corresponding to one of a plurality of lower blocks generated by splitting an upper block;
a reference sample determiner configured to determine reference samples of the current lower block based on samples adjacent to the upper block;
a predictor configured to determine a predicted value of a current sample comprised in the current lower block, by using the reference samples based on the intra prediction mode; and
a reconstructor configured to reconstruct the current lower block based on the predicted value,
wherein the current sample comprised in the current lower block is excluded from reference samples of another lower block comprised in the upper block.

12. A video encoding method comprising:
determining reference samples of a current lower block comprised in an upper block, among samples adjacent to the upper block;
determining an intra prediction mode of the current lower block, the intra prediction mode being optimized for the reference samples;
determining a predicted value of a current sample comprised in the current lower block, by using the reference samples based on the intra prediction mode; and
encoding the current lower block based on the predicted value,
wherein the current sample comprised in the current lower block is excluded from reference samples of another lower block comprised in the upper block.

13. (canceled)

14. A non-transitory computer-readable recording medium having recorded thereon a computer program for executing the video decoding method of claim 1.

15. A non-transitory computer-readable recording medium having recorded thereon a computer program for executing the video encoding method of claim 12.
